(19) United States
(12) Patent Application Publication
(10) Pub. No.: US 2007/0165049 A1
(43) Pub. Date: Jul. 19, 2007

(54) Configurable system and method for results review

(75) Inventors: David Phillip Murawski, Cary, IL (US); Steve Fors, (US); Mohan Naidu, Schaumburg, IL (US); Nirav Jitendra Shah, Ann Arbor, MI (US); Jay Nayanaveettil, Palatine, IL (US); Brandon Richard Savage, Barrington, IL (US); Afshar Sanam, (US); Krishna Prasad, (US); Nitin Mallya, (US); Vijay J. Bhatt, Bangalore (IN); Anees Syed, (US); Aravind Hiremath, Bangalore (IN); Brian Johnson, Brighton, MI (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/407,123

(22) Filed: Apr. 19, 2006

Related U.S. Application Data
(60) Provisional application No. 60/726,917, filed on Oct. 14, 2005.

(51) Int. Cl. G09G 5/00; G06T 11/20

(52) U.S. Cl. 345/619; 345/440; 345/156

(57) ABSTRACT

The system includes a remote computer-readable storage medium including a set of medical results for a plurality of patients and a computing device including a computer-readable storage medium, where the computer-readable storage medium includes a set of instructions for the computing device. The set of instructions includes a selection routine configured to select at least one of a plurality of views based on input from a user, where each of the plurality of views includes a template for presentation of a subset of the set of medical results to the user and a modification routine configured to dynamically modify the template of one or more of the views based on input from the user.

### RELATED APPLICATIONS

This application claims the benefit of U.S. Provisional Application No. 60/726,917, filed Oct. 14, 2005, entitled “Configurable System and Method for Results Review.” The '917 application is hereby incorporated by reference herein in its entirety.

### FEDERALLY SPONSORED RESEARCH OR DEVELOPMENT

Not applicable.

### BACKGROUND OF THE INVENTION

The present invention generally relates to the reviewing of medical examination or test results. More specifically, the present invention relates to the dynamic reviewing of medical results and the customization of a presentation of medical results to a user.

Many hospitals and clinics generate electronic medical data in response to examinations and tests. For example, upon performing a battery of tests on a patient's blood sample, a laboratory may generate electronic data to represent the results of the battery of tests. These results can then be reviewed by a physician, radiologist, nurse or other user.

However, the current systems and methods for reviewing medical results do not permit users to dynamically alter the manner in which the results are presented to the user. Current systems and methods use hardcoded, fixed reports for the presentation of results. These systems and methods do not provide for any configuration capability and do not allow a user to customize a report presenting results dynamically. Thus, a need exists for a system and method that permits users to dynamically alter the manner in Which results are reviewed. Such a system and method can provide for a comprehensive clinical description of a patient on a single computer screen. In addition, such a system and method can provide for the customization of the manner in which results are automatically presented to a user.

### BRIEF SUMMARY OF THE INVENTION

The presently described technology provides a method for customizing the presentation of results from medical examinations. The method includes selecting at least one of a plurality of views, where each of the plurality of views is configured to present medical results to a user, presenting the medical results according to the selected view, and dynamically modifying the selected view of the medical results based on input from the user.

The presently described technology also provides a computer-readable storage medium including a set of instructions for a computer. The set of instructions include a selection routine configured to select at least one of a plurality of views based on input from a user, where each of the plurality of views includes a template for presentation of one or more medical results to the user and a modification routine configured to dynamically modify the template of one or more of the views based on input from the user.

The presently described technology also provides a system for reviewing results from one or more medical examinations. The system includes a remote computer-readable storage medium including a set of medical results for a plurality of patients and a computing device including a computer-readable storage medium, where the computer-readable storage medium includes a set of instructions for the computing device. The set of instructions includes a selection routine configured to select at least one of a plurality of views based on input from a user, where each of the plurality of views includes a template for presentation of a subset of the set of medical results to the user and a modification routine configured to dynamically modify the template of one or more of the views based on input from the user.

### BRIEF DESCRIPTION OF SEVERAL VIEWS OF THE DRAWINGS

FIG. 1 illustrates a system for reviewing results from one or more medical examinations in accordance with an embodiment of the presently described technology.

FIG. 2 illustrates a screenshot presenting results in a summary mode in accordance with an embodiment of the presently described technology.

FIG. 3 illustrates a screenshot presenting results in a trend mode in accordance with an embodiment of the presently described technology.

FIG. 4 illustrates a trend view screenshot presenting a plot of results in trend mode in accordance with an embodiment of the presently described technology.

FIG. 5 illustrates a detailed view screenshot presenting results in a detailed mode in accordance with an embodiment of the presently described technology.

FIG. 6 illustrates a report form screenshot in accordance with an embodiment of the presently described technology.

FIG. 7 illustrates a laboratory result form screenshot presenting a laboratory result form in accordance with an embodiment of the presently described technology.

FIG. 8 illustrates a screenshot of a category manager tool in accordance with an embodiment of the presently described technology.

FIG. 9 illustrates a screenshot of a view manager tool in accordance with an embodiment of the presently described technology.

FIG. 10 illustrates a graph configuration screenshot in accordance with an embodiment of the presently described technology.

FIG. 11 illustrates a screenshot of a view manager tool in accordance with an embodiment of the presently described technology.

FIG. 12 illustrates a screenshot of a view configurator tool in accordance with an embodiment of the presently described technology.

FIG. 13 illustrates a flowchart for a method of results reviewing in accordance with an embodiment of the presently described technology.

The foregoing summary, as well as the following detailed description of certain embodiments of the presently described technology, will be better understood when read in conjunction with the appended drawings. For the purpose of illustrating the presently described technology, certain embodiments are shown in the drawings. It should be understood, however, that the presently described technology is not limited to the arrangements and instrumentality shown in the attached drawings.

### DETAILED DESCRIPTION OF THE INVENTION

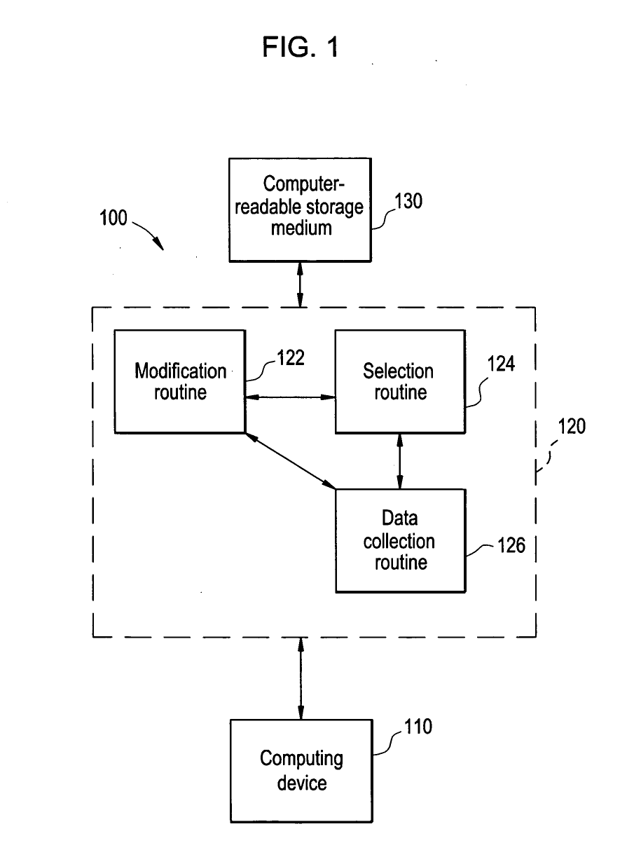

FIG. 1 illustrates a system 100 for reviewing results from one or more medical examinations in accordance with an embodiment of the presently described technology. System 100 includes a computing device 110, a set of instructions 120 for said computing device 110, and a computer-readable storage medium 130.

Computing device 110 (or “computer 110”) can be embodied in any apparatus or system capable of performing operations according to one or more sets of instructions. For example, computer 110 can include a desktop computer, a handheld digital assistant (such as a Palm device), a computer workstation (such as that in a PACS system), or a laptop computer. Computer 110 can include one or more output devices such as a display device, printer, and/or speakers. The display device can include a computer monitor, for example. Computer 110 can include one or more input devices such as a mouse, stylus, keyboard, and/or microphone. While a single computing device 110 is shown in FIG. 1, system 100 can include multiple computing devices 110. In addition, while computing device 110 is schematically illustrated in FIG. 1 as comprising a single “box,” one having ordinary skill in the presently described technology will recognize that a computing device 110 can be embodied in multiple “boxes” collectively operating together to achieve one or more desired functions.

Set of instructions 120 can be embodied in one or more computer software applications. For example, set of instructions 120 can include one or more software modules or routines. Set of instructions 120 includes a modification routine 122, a selection routine 124, and a data collection routine 126, each of which is described in more detail below. Each of routines 122 through 126 can be embodied in a separate software application or can be partially or entirely grouped together in a software application, as recognized by one having skill in the presently described technology.

Set of instructions 120 are stored on one or more computer-readable storage media. A computer-readable storage medium can include an internal computer memory, a removable computer memory (such as a floppy disk, CD or DVD), or an external computer memory (such as memory in one or more servers accessible to computing device 110), for example. In an embodiment, set of instructions 120 are stored on a computer memory internal to computing device 110. For example, set of instructions 120 can be stored on a computer hard drive of device 110. In another embodiment, set of instructions 120 are stored on a computer memory external to computing device 100. For example, set of instructions 120 are stored on a computer memory in a server accessible to computing device 110. In another embodiment, a portion of set of instructions 120 are stored on a computer memory internal to computer device 110 and the remainder of set of instructions 120 are stored on a computer memory external to computing device 100.

Computer-readable storage medium 130 (or “memory 130”) includes a computer memory such as that described above with regard to set of instructions 120. Memory 130 includes medical data, such as results from one or more medical examinations. In an embodiment, memory 130 is a different computer-readable storage medium on which set of instructions 120 is located. In another embodiment, memory 130 is the same computer-readable storage medium on which set of instructions 120 is stored.

The results can include data obtained from a laboratory. For example, a laboratory can conduct a battery of tests on a patient's blood sample. The various results from these tests can be input onto memory 130 by the laboratory.

Computer 110 communicates with set of instructions 120 over a wired or wireless connection. Computer 110 also employs set of instructions 120 to carry out one or more steps of the technology presently described herein. Computer 110 uses, or communicates with, one or more routines 122 through 128 of set of instructions 120, to access and present medical results and data stored on memory 130. Therefore, memory 130 also communicates with or uses one or more routines 122 through 128 of set of instructions 120.

In operation, a user employs computing device 110 to access and view medical results stored at memory 130. A user can be any individual, such as a doctor, physician, radiologist, nurse, or hospital administrator, for example. Medical results stored at memory 130 can include any medical data. For example, medical results can include results from a laboratory test, measurements of a patient's vital signs, notes from a user (such as a doctor, physician, radiologist, nurse, or hospital administrator), current and/or past orders (such as prescription orders, laboratory orders, and/or treatment orders), laboratory reports, user reports, flowsheets (such as nursing flowsheets), and/or comparison studies (such as comparisons between results for a particular patient and/or across multiple patients).

Using the presently described technology, a user can customize which results are presented to him or her and the manner in which the results are presented. In addition, system 100 can provide a comprehensive visual snapshot of one or more patients' statuses. A user initially logs on to system 100 by providing a user identity to computing device 110. For example, a user can provide a user ID and/or password. Once the user's user identity has been verified, the user can employ an input device connected to computer 110 to select one or more patients whose results the user wants to review. For example, the user can select one or more names from a list of patient names.

Once the user has selected one or more patient names, the user can select a mode of display. A mode of display is a manner of presenting results according to one or more views, or templates. For example, a mode of display can include a summary mode, a trend mode, and a detailed mode. A mode of display presents a screenshot of results according to the mode and/or a view selected by the user, as described in more detail below.

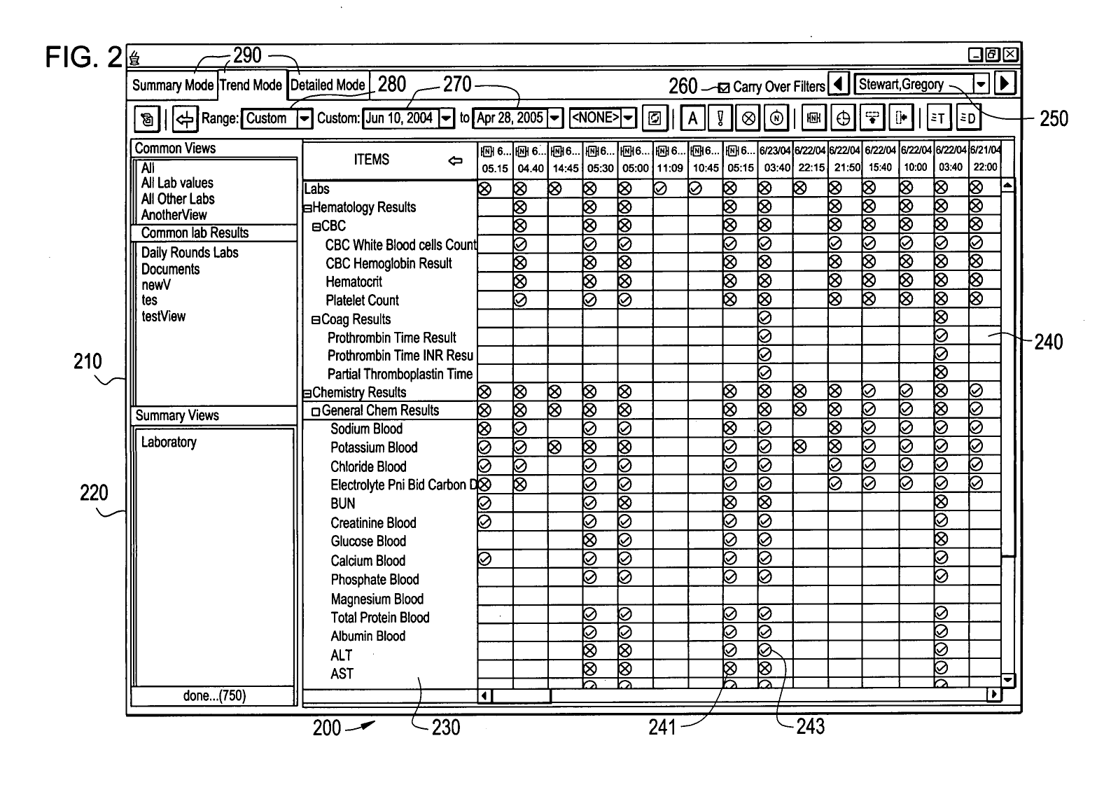

FIG. 2 illustrates a summary view screenshot 200 presenting results in summary mode in accordance with an embodiment of the presently described technology. In an embodiment, modification routine 122 causes a display device connected to computing device 110 to present screenshot 200 to a user. While screenshot 200 is provided as an example, it should not be construed as a limitation of an embodiment of the presently described technology. Summary view screenshot 200 includes a common view window 210, a summary view window 220, an item list 230, a results window 240, a patient identification 250, a carry-over filter button 260, a plurality of range pull-down menus 270, a range selection pull-down menu 280, and a plurality of mode tabs 290.

In summary mode, a user can be initially presented with one or more icons representing results or measurements such as laboratory test results, doctor's reports, and doctor's notes and/or fluids administered to and/or released from the patient. As described in more detail below, these icons can visually indicate whether one or more represented results, measurements or fluids are normal, abnormal or critical. A user can select or “click” on one of the icons to retrieve additional information about the results/measurements/fluids represented by the icon. For example, if an icon represents several laboratory test results obtained over a given time period, by clicking on the icon the user is presented with the various results represented by the icon. The user can continue to click on an individual result and “drill down” to obtain additional information such as all other results obtained at the same time as the selected result or the report that accompanied the result from the laboratory or the order that was used to obtain the laboratory test.

Mode tabs 290 include a plurality of graphical tabs that indicate which modes are available for a user to select. In addition, mode tabs 290 can indicate which mode is currently active. For example, by changing the type or font of the current mode in one of mode tabs 290, the current mode can be indicated. For example, in FIG. 2, a mode tab 290 labeled “Summary Mode” includes boldface type indicating that the current mode is “Summary Mode.”

In an embodiment, mode tabs 290 are continually presented by modification routine 122 to users of system 100. A user may therefore employ an input device at any time to select one of tabs 290 to change modes.

When a user has selected a tab 290, selection routine 124 receives the user's selection as user input and communicates the change in mode to modification routine 122. Modification routine 122 then changes the mode displayed to the user to correspond to the selected tab 290. For example, a user can select either of mode tabs 290 labeled “Trend Mode” or “Detailed Mode” to change the current mode from “Summary Mode” to either “Trend Mode” or “Detailed Mode.”

Each of the modes available to a user enables the user to select one more views of medical results. That is, for each mode, one or more views of results are available. A view of medical results is a template for the presentation of medical results to a user. Each view can present the same or different medical results in a different manner. A template can determine the layout, icons, text and graphical representation(s) of medical results. For example, a template can include a spreadsheet, a chart, a graph, and/or a list. Several views are available to present medical results in accordance with an embodiment of the presently described technology.

A view includes a presentation of one or more subsets of medical results to a user. In general, all medical results available for viewing by a user can be stored on one or more computer-readable storage media such as medium 130. All medical results available for viewing by a user are referred to as a “universe” of medical results.

As described in more detail below, a view can be customized to present a particular subset of the universe of medical results. Views can be predefined by other users (such as an administrator, for example) and/or can be created and saved for later recall by a user. A user employs an input device such as a computer mouse or stylus to select a view in a particular mode to present medical results.

In an embodiment, modification routine 122 causes common view window 210 to display a list of one or more views to a user that can be selected and presented to a user in any one of the modes available to the user. For example, if a view is listed in common view window 210, then that view (and the categories and items of medical results associated with that view and the medical results themselves) can be presented to in a summary mode of display, a trend mode of display, and a detailed mode of display.

When a user selects a view, then the user's selection is communicated as user input from computing device 110 to selection routine 124. Selection routine 124 communicates the selection to modification routine 122. Modification routine 122 then causes data selection routine 126 to accesses medical results stored at one or more computer-readable storage media such as medium 130 to obtain the results that are to be displayed in the selected view. Upon obtaining the relevant results, the results are displayed according to the selected view.

Similar to common view window 210, summary view window 220 displays a list of one or more views of results that can be selected and presented to a user in a summary view. However, the views listed in summary view window 220 can only be displayed in a summary view. These views generally cannot be displayed in a trend view or detailed view, for example.

If a user wishes to change the view selected in window 210, he or she can use an input device connected to computer 110 to select a different view displayed in common view window 210 and/or summary view window 220. Set of instructions 120 then obtains and presents the relevant results to the user, as described above.

In an embodiment, modification routine 122 causes results window 240 to display the results included in item list 230 to a user on computing device 110. Item list 230 is a list of medical result items that are displayed in results window 240 for the selected view. Item list 230 is created by and communicated to computing device 110 by modification routine 122. A medical result item is a label associated with a type or item of medical result. A type or item of medical result is a name commonly associated with a particular result. For example, “Hematology Results,” “HIV test,” “CBC,” “Coag Results,” “Chemistry Results,” “General Chemistry Results,” and “Hemaglobin A1C” can be types or items of medical results, such as laboratory test results.

In an embodiment, a type or item of medical result listed in item list 230 can be a plurality of results grouped together. Results can be grouped together according to one or more variables. For example, a type or item of result can include all medical results associated with one or more common variables, common values for one or more variables, and/or common text for one or more variables. In another example, a type or item of medical result can include all results that are obtained from a single laboratory test or similar laboratory tests. For example, in item list 230 of screenshot 200, several items or types of results obtained from a single laboratory test or similar laboratory tests are grouped together under the listings of “Hematology Results” and “Chemistry Results.”

In an embodiment of the presently described technology, an item or type of results can include one or more subcategories, or subsets of results. For example, the “Hematology Results” item in item list 230 includes two subcategories, namely “CBC” and “Coag Results.”

A variable can be any data or information included in medical data. For example, a variable can include one or more of a type (or item) and/or range of laboratory test results, vital sign measurements, fluids administered to a patient, and/or fluids measured from a patient. A variable can include text from notes, laboratory reports, examination reports, one or more captions to a laboratory test result, vital sign measurement, and/or fluids administered to/measured from a patient, an order for a laboratory test, treatment and/or prescription, and/or a name.

A type (or item) of laboratory test result can be associated with a measured result from a particular laboratory test. For example, in the item “Hematology Results” and the subcategory “CBC,” several types or items of laboratory test results are displayed, including “CBC Hemoglobin Result” and “Platelet Count.”

A range is a range of measurements in one or more results. For example, a range can include a range of laboratory test results, such as a blood glucose measurement of 70-120 mg/dL. In another example, a range can include a range of measurements of cholesterol, white blood cell counts, platelet counts, hematocrit, CBC hemoglobin results, sodium, potassium, chloride, and total protein. A range can also or alternatively include a range of vital sign measurements, fluids administered to a patient, and/or fluids measured from a patient (such as fluids expelled by a patient), for example.

As medical results can include text from user's notes, laboratory reports, examination reports, captions to a laboratory test result, vital sign measurement, and/or fluids administered to/measured from a patient, an order for a laboratory test, treatment and/or prescription, a variable can include text that is included in one or more of these items. For example, a variable can include the text string “platelet count.” Therefore, any text from a user's notes, laboratory reports, examination reports, captions to a laboratory test result, vital sign measurement, and/or fluids administered to/measured from a patient, an order for a laboratory test, treatment and/or prescription that includes the text “platelet count” can be included in an item defined by a variable of the text “platelet count.” In addition, a text variable can include text from a user's name and/or patient's name.

In an embodiment of the presently described technology, modification routine 122 can cause patient identification 250 to be presented to a user on computing device 110. Patient identification 250 includes a listing of a patient or patients. The patient(s) listed in patient identification 250 is/are the patients that the results displayed in results window 240 are associated with. In other words, the test results shown in results window 240 are results from a test administered to the patient(s) identified in patient identification 250.

In an embodiment of the presently described technology, modification routine 122 can cause carry over filter button 260 to be presented to a user on computing device 110. Carry over filter button 260 is a button that can be selected by a user to cause any filters selected by a user to be carried over to another patient, view, and/or mode of display. A filter can be employed by a user to reduce the number of medical results displayed in results window 240.

A filter can be used to filter medical results data presented to a user according to one or more variables. For example, when a filter is selected by a user, modification routine 122 applies the filter to the results displayed to the user in the current view by removing from display all medical results that do not fall within the filter. As described above, a variable can be any data or information included in medical data. For example, a variable can include one or more of a type (or item) and/or range of laboratory test results, vital sign measurements, fluids administered to a patient, and/or fluids measured from a patient. A variable can include text from notes, laboratory reports, examination reports, one or more captions to a laboratory test result, vital sign measurement, and/or fluids administered to/measured from a patient, an order for a laboratory test, treatment and/or prescription, and/or a name. By specifying one or more limits on one or more variables, a user can create a filter to be applied to results presented in results window 240.

In an embodiment, a filter is a time-based filter. For example, a filter can be created that causes only results that have been updated to computer-readable storage medium 130 since a user last accessed the results data. In another example, a user can specify an initial date from which to present all results obtained after that date.

Filters can be created dynamically, or while a user is reviewing data. Filters can also be created and saved for later use. For example, a user can create a filter and communicate the filter from computing device 110 to modification routine 122. Modification routine 122 can then cause the filter to be saved at computer readable storage medium 130 and/or some other computer readable storage medium accessible by computer 110.

Filters can also be previously defined. For example, a first user can create a filter that is later retrieved from a memory (such as computer readable storage medium 130 and/or some other computer readable storage medium accessible by computer 110) by a second user and applied to medical results presented in results window 240.

In an embodiment of the presently described technology, modification routine 122 can cause range pull-down menus 270 to be presented to a user on computing device 110. Range pull-down menus 270 include a plurality of listings of dates that can be selected by a user to reduce or expand the date range of medical results displayed in results window 240. For example, if a user selects Jun. 10, 2004 in a first custom range pull-down menu 270 and Apr. 28, 2005 in a second custom range pull-down menu 270, then only results obtained between Jun. 10, 2004 and Apr. 28, 2005 are presented in results window 240. Range pull-down menus 270 can be employed to view medical results across any time period of available medical results. For example, a user can expand or contract a date range in menus 270 to view medical results across days, weeks, months and/or years.

When a user selects a date in either of menus 270, the user input is communicated to modification routine 122. Modification routine 122 then removes all results not falling within the dates selected by the user from display on computing device 110.

In an embodiment of the presently described technology, modification routine 122 can cause range selection pull-down menu 280 to be presented to a user on computing device 110. Range selection pull-down window 280 includes a list of previously defined ranges and a custom range that can be selected by a user. For example, upon clicking window 280, a listing of pre-set ranges can appear. By selecting a given range listed in window 280, windows 270 can change their displayed values to correspond to a starting date and an ending date for the date range of medical results displayed in results window 240. For example, upon selecting range selection pull-down window 280, the following list may appear:

DATE #1-DATE #2
DATE #2-DATE #3
DATE #3-DATE #4
DATE #4-DATE #5
Custom
All Results

where “DATE#X” represents a date and/or time.

A user can then select any of these date ranges to limit the results displayed in results window 240 to the results obtained within the selected date range. The user's selection is then communicated to modification routine 122 as user input. Modification routine 122 then determines which results do not fall within the selected date range and should therefore not be displayed to the user on computing device 110. If a user selects “Custom,” then the user can customize the beginning and ending dates of a custom range using range pull-down menus 270, as described above. While the above list includes various date ranges, these dates are included merely as examples and not as a limitation on the presently described technology. A user can save a customized or preset date range as a filter, as described above. In addition, a user can select “All Results” in menu 280 to remove all filters and display all medical results selected in common view window 210.

In an embodiment of the presently described technology, a given mode includes only a certain number of views available for the presentation of medical results. For example, only certain views can be displayed when system 100 is in summary mode. In an embodiment, summary mode can present medical results only according to one or more views listed in common view window 210 and/or summary view window 220.

In an embodiment, while in summary mode summary mode, modification routine 122 causes medical results to be displayed in a spreadsheet of medical results listed according to the type (or item) of medical result and a date and/or time that the medical result was obtained. For example, results window 240 in FIG. 2 illustrates a common view of the medical results listed in item list 230 according to the date and time that the medical results were obtained.

In an embodiment, while in summary mode, modification routine 122 causes one or more results can be presented as a graphical icon at computing device 110. For example, in results window 240 of screenshot 200, the medical results are displayed as one of two graphical icons 241 and 243. Graphical icons can be used to visually represent a result. For example, different graphical icons can be used to represent medical results that are normal, abnormal, and/or critical (or panic). In results window 240 of screenshot 200, icon 241 represents a medical result that is abnormal while icon 243 represents a medical result that is normal. An abnormal result is a result that is either larger (or higher) or smaller than an expected result. A critical or panic result can be a medical result that requires immediate attention of a doctor, physician, or nurse, for example. While an “X” is used as icon 241 and a checkmark is used as icon 243, in accordance with the presently described technology, another graphic demonstrating an abnormal or normal result can be used for icon 241 and/or icon 243.

In another embodiment, results can be time compressed and represented as a graphical icon. For example, if the results are time compressed, all results over a given time period are combined into a single graphical icon. Based on previously established rules or criteria, if the number of results over the given time period that are considered abnormal (that is, are outside of a preferred range) exceeds a threshold, then an abnormal icon 241 can be used to represent the time compressed results. On the other hand, if the number of results over a given time period that are considered abnormal is at or below a threshold, then a normal icon 243 can be used to represent the time compressed results.

A user can employ an input device to select one or more graphical icons. For example, upon seeing that abnormal icon 241 is displayed in results window 240 of screenshot 200 for medical result item “Chemistry Results” (that were obtained on Jun. 23, 2004, at 3:40 a.m.), a user can click on the abnormal icon 241 that corresponds to these results using a computer mouse device or stylus. When the icon is selected, the selection is communicated to data collection routine 126 as user input. Data collection routine 126 then accesses computer-readable storage medium 130 to obtain additional details related to the corresponding medical result is presented to the user. For example, when a given icon is selected (corresponding to a selected test result), data collection routine 126 can obtain the actual measured result (for example, a number and measurement units). This measured result can then be communicated to modification routine 122 which presents the result to the user. In another example, all results that were obtained at the same time the selected test result was obtained can be obtained by data collection routine 126 and presented to the user by modification routine 122. In another example, the time and/or date of the medical result can be presented. In another example, an identity of the medical practitioner that administered the medical examination (resulting in the selected result) can be presented. In another example, a reason for why the selected result was abnormal, critical, or normal can be presented. For example, if a result is abnormal and is selected by a user, the exact test result given in measurement units can be presented along with a range of measurements considered normal by system 100. Therefore, the test result is displayed along with a normal range to notify the user how “abnormal” the test result is compared to a “normal” range.

In an embodiment, modification routine 122 causes fluid inputs and outputs for a patient can be presented at computing device 110. For example, in results window 240 of screenshot 200, fluids input to a patient as well as fluids expelled from a patient can be displayed. These fluids can be presented along with other laboratory results so that a user can readily see any correlation between fluids administered to or measured from a patient and one or more results.

In an embodiment of the presently described technology, modification routine 122 causes results window 240 in the summary mode displayed in screenshot 200 to present only those results that are abnormal and/or critical. In other words, no normal results are displayed in results window 240. Such a presentation of results can be preferred where a user only wishes to see a quick summary of all abnormal and/or critical results for a given patient, for example.

In an embodiment of the presently described technology, a user can select one or more icons 241, 243 in summary mode and cause these results to be presented in another mode. For example, if time compression is active or turned on and a given icon represents a plurality of results, by selecting the icon and then selecting a button or icon that causes the mode to switch to either detailed mode or trend mode, the results selected by the user are then displayed to the user in the selected mode.

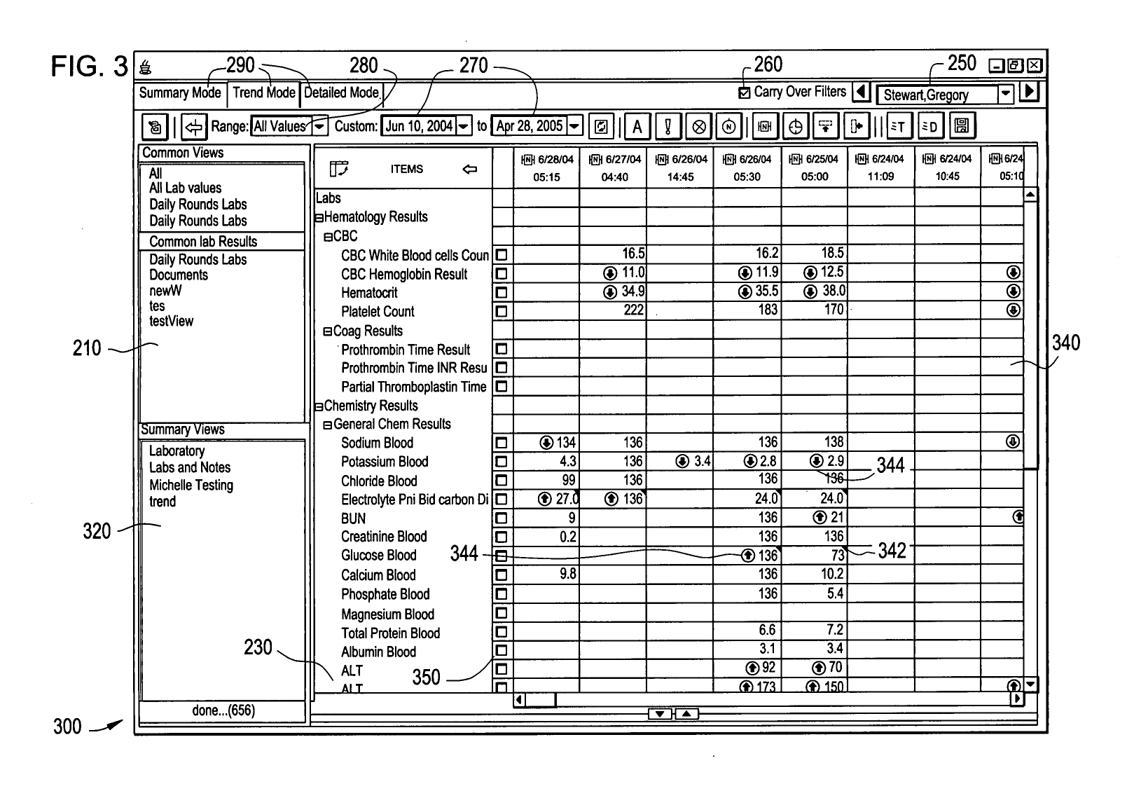

FIG. 3 illustrates a screenshot 300 presenting results in a trend mode in accordance with an embodiment of the presently described technology. In an embodiment, modification routine 122 causes a display device connected to computing device 110 to present screenshot 300 to a user. While screenshot 300 is provided as an example, it should not be construed as a limitation of an embodiment of the presently described technology. Trend view screenshot 300 includes a common view window 210, a trend view window 320, an item list 230, a trend results window 340, an item selection window 350, a patient identification 250, a carry-over filter button 260, a plurality of range pull-down menus 270, a range selection pull-down menu 280, and a plurality of mode tabs 290.

Common view window 210, item list 230, patient identification 250, carry-over filter button 260, range pull-down menus 270, range selection pull-down menu 280, and mode tabs 290 are described above. In an embodiment, modification routine 122 causes trend view window 320 to display a list of views that can be presented to a user in trend mode to a user on computing device 110. The views listed in common view window 210 can be viewed in any one or more of summary, trend and detailed modes. In an embodiment, the views listed in trend view window 320 can only be viewed in trend mode.

If a user wishes to change the view selected in window 210 or window 320, he or she can use an input device connected to computer 110 to select a different view displayed in common view window 210 and/or trend view window 320. When a user selects a view, then the user's selection is communicated as user input from computing device 110 to selection routine 124. Selection routine 124 communicates the selection to modification routine 122 and data collection routine 126. Data collection routine 126 accesses medical results data stored at one or more computer-readable storage media such as medium 130 to obtain the results that are to be displayed in the selected view. Upon obtaining the relevant results, the results are communicated to modification routine 122 which then displays the results according to the selected view.

In an embodiment, modification routine 122 causes trend results window 340 to display the medical examination results included in item list 230 to a user on computing device 110.

In an embodiment, modification routine 122 causes item selection window 350 to display one or more selection boxes to a user that can be selected by a user. Each selection box in window 350 corresponds to a result included in item list 230.

In trend mode, medical results are displayed over a period of time. For example, medical results can be presented in a spreadsheet listed according to the type (or item) of medical result and a date and/or time that the medical result was obtained, similar to summary mode described above. For example, trend results window 340 in FIG. 3 illustrates a trend view of the medical results listed in item list 230 according to the date and time that the medical results were obtained.

In an embodiment, in addition to presenting the medical results, in trend mode, modification routine 122 causes one or more of a comment indicator 342 and/or a trend indicator 344 is presented with one or more results in trend results window 340.

Comment indicator 342 can be presented in a cell with a result if a user has included a comment with the result. For example, an administrator, doctor, physician, radiologist, and/or nurse can include a notation or caption with a test result. A user can view the comment indicated by comment indicator 342 by selecting the cell that includes the result and indicator 342 with an input device. The user's selection is communicated to data collection routine 126. Data collection routine 126 then accesses the comment from the data stored at computer-readable storage medium 130 and communicates the comment to modification routine 122 for presentation to the user.

Trend indicator 344 can be presented in a cell with a result to demonstrate an increasing or decreasing trend in the corresponding result. An increasing or decreasing trend can be an increase or decrease in a measured result from a previous measured result. For example, in trend results window 340 of screenshot 300, the result for hematocrit obtained on Jun. 26, 2004, at 5:30 a.m. is less than the results for hematocrit previously obtained on Jun. 25, 2004, at 5:00 a.m. Therefore, indicator 344 (including a downward arrow) can be included in the cell with the result for hematocrit obtained on Jun. 26, 2004, at 5:30 a.m., for example. While an upward arrow is used as an increasing trend indicator 344 and a downward arrow is used as a decreasing trend indicator 344 in screenshot 300, in accordance with the presently described technology, any graphic can be used in place of either the increasing or decreasing trend indicators 344.

In accordance with an embodiment of the presently described technology, the order in which results are displayed in trend result window 340 can be altered. In screenshot 300, the results are listed in reverse chronological order when reading from left to right. The results can be listed in chronological order when reading from left to right.

In accordance with an embodiment of the presently described technology, all results obtained after a given date and/or time can be flagged. For example, an additional graphical icon can be added to the cell(s) of one or more results obtained after a date and/or time set by a user. A user can set the date and/or time as part of his or her preferences or customization selections stored at computer-readable storage medium 130 and/or computing device 110, as described in more detail below. Modification routine 122 then directs modification routine 122 to display the additional graphical icon for each result obtained after the date and/or time. In another example, all results obtained since the last time the user reviewed the results displayed in a given view are automatically flagged. In other words, if a user routinely reviews results for a given patient in a view entitled “Daily Rounds Labs,” then each time the user accesses the results for the patient in trend mode in “Daily Rounds Labs,” all results that have been added since the previous time the user viewed the results are flagged.

Similar to the filters that can be applied in summary mode, one or more filters can be applied to the results presented in trend mode. For example, a user can employ windows 270 and/or 280 to set a date range in order to filter out certain results. Once the filter is set by the user, only results with values and/or dates and/or times within the filter are presented in trend results window 340.

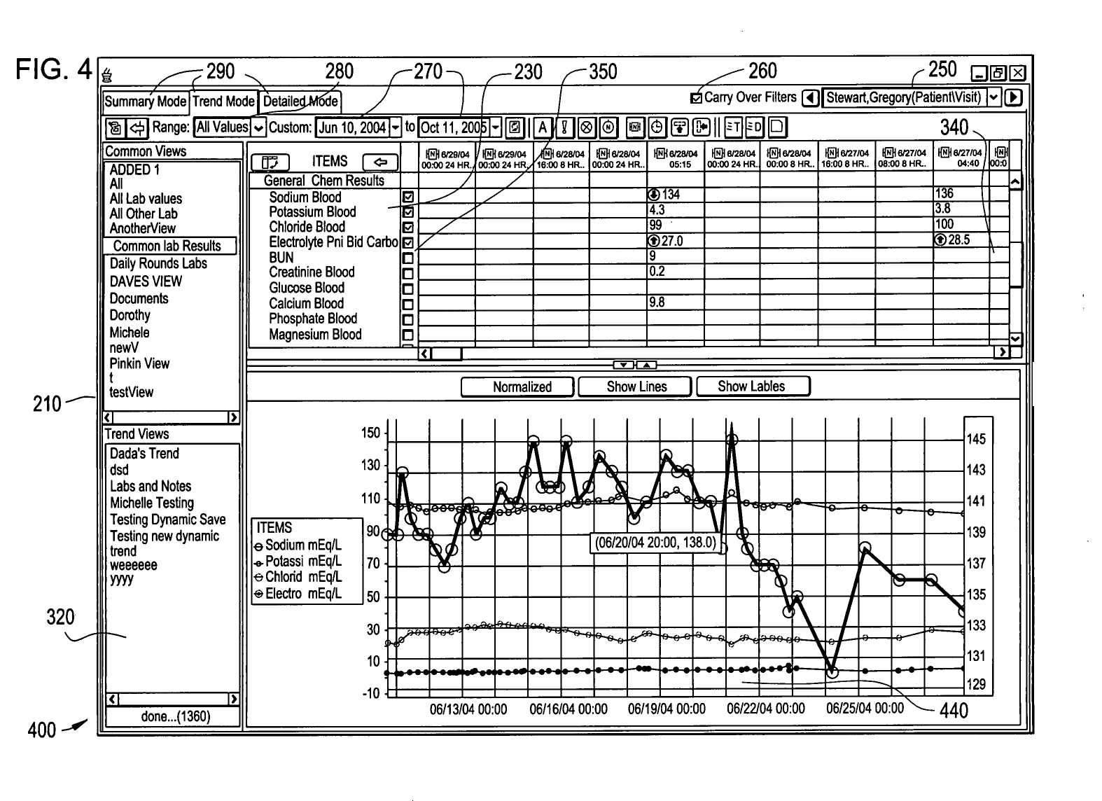

Trend mode can also be employed by a user to plot out results from one or more items listed in item list 230 of screenshot 300. FIG. 4 illustrates a trend view screenshot 400 presenting a plot of results in trend mode in accordance with an embodiment of the presently described technology. In an embodiment, modification routine 122 causes a display device connected to computing device 110 to present screenshot 400 to a user. While screenshot 400 is provided as an example, it should not be construed as a limitation of an embodiment of the presently described technology. Screenshot 400 includes common view window 210, trend view window 320, trend results window 340, patient identification 250, carry-over filter button 260, item selection window 350, item list 230, range pull-down menus 270, range selection pull-down menu 280, mode tabs 290, and a plot of results 440.

Common view window 210, trend view window 320, trend results window 340, patient identification 250, carry-over filter button 260, item selection window 350, item list 230, range pull-down menus 270, range selection pull-down menu 280, and mode tabs 290 are described above.

Plot of results 440 is a graphical representation or graph of one or more medical results selected in item selection window 350 with respect to time. The specific plot 440 in screenshot 400 is included merely as an example and is not to be construed as a limitation on the presently described technology. A user can employ an input device to select one or more of the results displayed in trend results window 340 by selecting a corresponding box in item selection window 350. Once the results are selected, the results are communicated to selection routine 124. Selection routine 124 communicates the selection to data collection routine 126. Data collection routine 126 accesses the data corresponding to the selected medical results stored at one or more computer-readable storage media such as medium 130. Upon obtaining the selected results, the results are communicated to modification routine 122. Modification routine 122 then graphs the selected results in a plot 440, which is then presented to the user.

A user can therefore obtain a quick graphical representation of one or more results plotted versus time for easy comparison and analysis. For example, a user can cause a patient's temperature and blood count to be plotted versus time. The user can then see any correlation between the patient's temperature and blood count, for example. The user can also use the plot to determine if there are any trends between the temperature and blood count and/or any response in temperature or blood count to medical or other treatment at a known time, for example.

A plot 440 can be customized by a user. For example, a user can communicate input from computing device 110 to modification routine 122 to change the scale or range of either one of the axes, the presence or absence of line used to represent a given results in plot 440 (by selecting the “Show Lines” button in screenshot 400, for example), and/or cause a label (such as the actual value, for example) to be provided for each result in plot 440 (by selecting the “Show Labels” button in screenshot 400, for example). In addition, a user can cause the results to be normalized by selecting the “Normalized” button in screenshot 400. A user can also zoom, or magnify, results data in plot 440.

In an embodiment of the presently described technology, the results displayed in a plot 440 can be temporarily displayed. For example, a user may select one or more results to be plotted versus time in plot 440. The user can then, using an input device, highlight or temporarily select an additional result to be temporarily plotted versus time along with the other results already plotted in plot 440. For example, by moving a cursor or arrow (controlled by a computer mouse or other input device) over a result not already plotted in plot 440, modification routine 122 can cause that result to be displayed in plot 440 as if it had been selected in window 350. In doing so, a user can temporarily change the results plotted in plot 440 to obtain a quick comparison of additional results not already plotted in plot 440.

In an embodiment of the presently described technology, the results displayed in a plot 440 can be dynamically altered. For example, a user may select one or more results to be plotted versus time in plot 440. The user can then, using an input device, select one or more additional results to be plotted versus time along with the other results already plotted in plot 440. A user can also de-select one or more results to be plotted versus time in plot 440. For example, using an input device, the user can un-check or de-select one or more of the results plotted versus time in plot 440 and cause those results to no longer be plotted. This input is then communicated to modification routine 122. By selecting an additional result in window 350 that is not already plotted in plot 440, modification routine 122 can cause that result to also be displayed in plot 440.

In an embodiment, modification routine 122 can cause one or more normal ranges or results to be plotted along with the results selected in window 350. For example, one or more results selected by a user (as described above) can be plotted in the same plot 440 as a normal range for the same laboratory result. The normal or expected result can be plotted as one or more lines or as a shaded box. Data collection routine 126 can access the normal or expected result value(s) or range(s) from one or more computer-readable storage media, such as medium 130. The normal result value(s) or range(s) can then be communicated to modification routine 122 for presentation in plot 440 on computing device 110. In doing so, a user can obtain a quick comparison to an actual medical result versus an expected, or normal result versus time in plot 440.

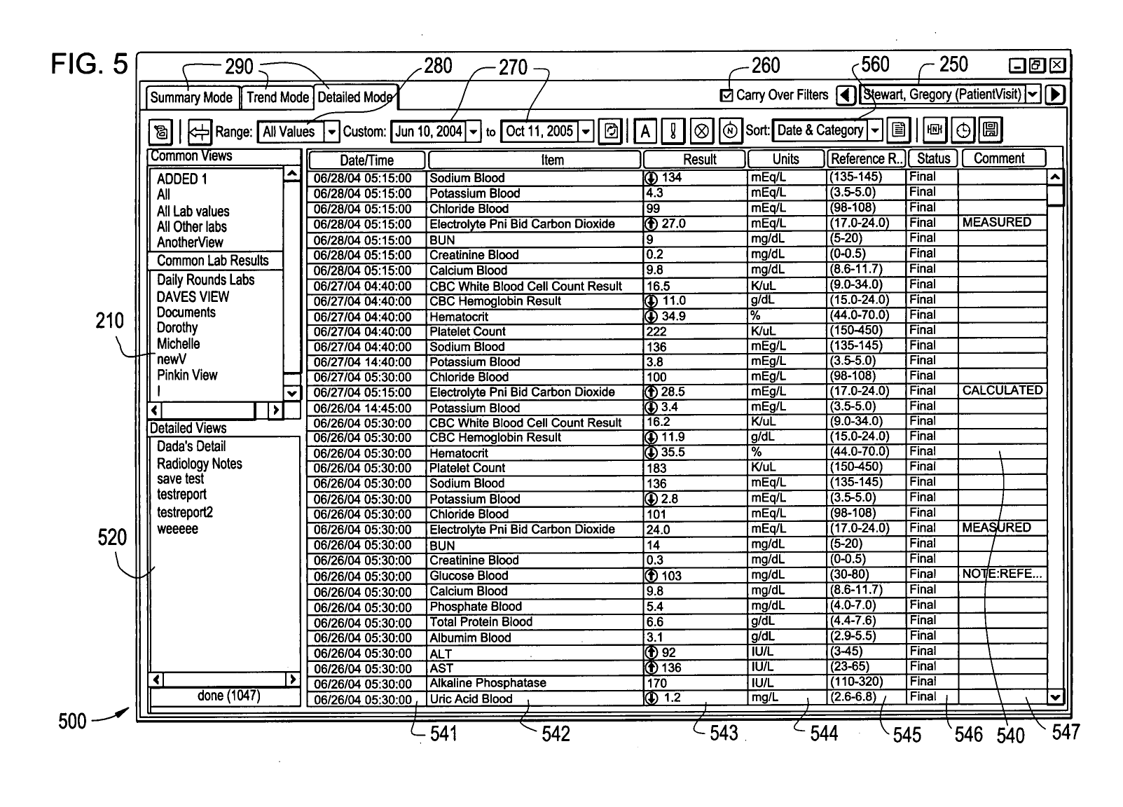

FIG. 5 illustrates a detailed view screenshot 500 presenting results in a detailed mode in accordance with an embodiment of the presently described technology. In an embodiment, modification routine 122 causes a display device connected to computing device 110 to present screenshot 500 to a user. While screenshot 500 is provided as an example, it should not be construed as a limitation of an embodiment of the presently described technology. Screenshot 500 includes common view window 210, patient identification 250, carry-over filter button 260, range selection pull-down menu 280, range pull-down menus 270, mode tabs 290, detailed view window 520, detailed results window 540 and sort pull-down menu 560.

Detailed results window 540 includes several columns of information, including a date/time column 541, an item column 542, a result column 543, a unit column 544, a reference column 545, a status column 546, and a comment column 547. Common view window 210, patient identification 250, carry-over filter button 260, range selection pull-down menu 280, range pull-down menus 270 and mode tabs 290 are described above.

In detailed mode, modification routine 122 can present additional details of one or more results to a user on computing device 110 in detailed results window 540. Detailed results window 540 can present the user with one or more results in addition to one or more of a date and/or time that the result was obtained (displayed in date/time column 541, for example), an item description of the result (displayed in item column 542, for example), the measurement of the result (displayed as a number in result column 543, for example), a measurement unit (displayed in unit column 544, for example), a normal or expected result or range of results (displayed in reference column 545, for example), a status of the result (displayed in result column 546, for example), and a comment entered by one or more users (displayed in comment column 547, for example).

The item description of the result can include a name commonly associated with a measured result from a particular laboratory test. For example, “sodium blood,” “platelet count,” and “glucose blood” are item descriptions of a result.

In an embodiment, in addition to displaying the measurement of the result in result column 543, modification routine 122 can cause a trend icon 344 such as that displayed in screenshots 300 and 400 to be displayed on computing device 110 to notify a user that the measured result has changed with respect to a previous measured result.

The status of the result can indicate whether the result displayed in detailed view window 540 is part of a completed test or examination or is part of an ongoing or continuing test or examination. For example, a result displayed in detailed result window 540 can be associated with a status of “Final” if the laboratory test used to obtain the result is complete. In another example, a result displayed in detailed result window 540 can be associated with a status of “Not final” or “Pending” if the laboratory test used to obtain the result is not complete or is pending completion upon certification.

In an embodiment, any one or more of columns 541 through 547 can be selected by a user employing an input device to cause all or some of the displayed results to be sorted according to the selected column. The user's selection is communicated from computing device 110 to modification routine 122, which then causes the displayed results to be sorted. For example, if a user selects the “Date/Time” button at the top of date/time column 541, all results displayed in window 540 can be sorted in ascending or descending order based on the date and/or time for each result.

Sort pull-down menu 560 can be selected by a user to present several options for sorting the results displayed in window 540. For example, upon selecting menu 560, a user can be presented with several sorting options, including “Date & Category” and “Category & Date.” Once a sorting option is selected, the selection is communicated to modification routine 122, which then sorts the results according to the option. For example, if a user selects “Date & Category” as a sorting option, then modification routine 122 causes the results in window 540 to be sorted into categories for each date. In other words, the results are grouped according to date, and within each date the results are grouped and listed according to the category of each result. In another example, if a user selects “Category & Date” as a sorting option, then modification routine 122 causes the results in window 540 to be sorted into dates for each category. In other words, the results are grouped according to category, and within each category the results are grouped and listed according to the date of each result.

In an embodiment of the presently described technology, a user may select one or more results displayed in one or more of results window 340, 540 to view additional results associated with the selected result. For example, by employing an input device to select a given result in detailed results window 540, a user's selection of one or more results is communicated to data collection routine 126. Data collection routine 126 can then access a database in computer-readable storage medium 130 to determine if additional results were obtained at the same time that the selected result was obtained. If additional results were obtained, these results can be communicated to modification routine 122 and then displayed on computing device 110 in a report form.

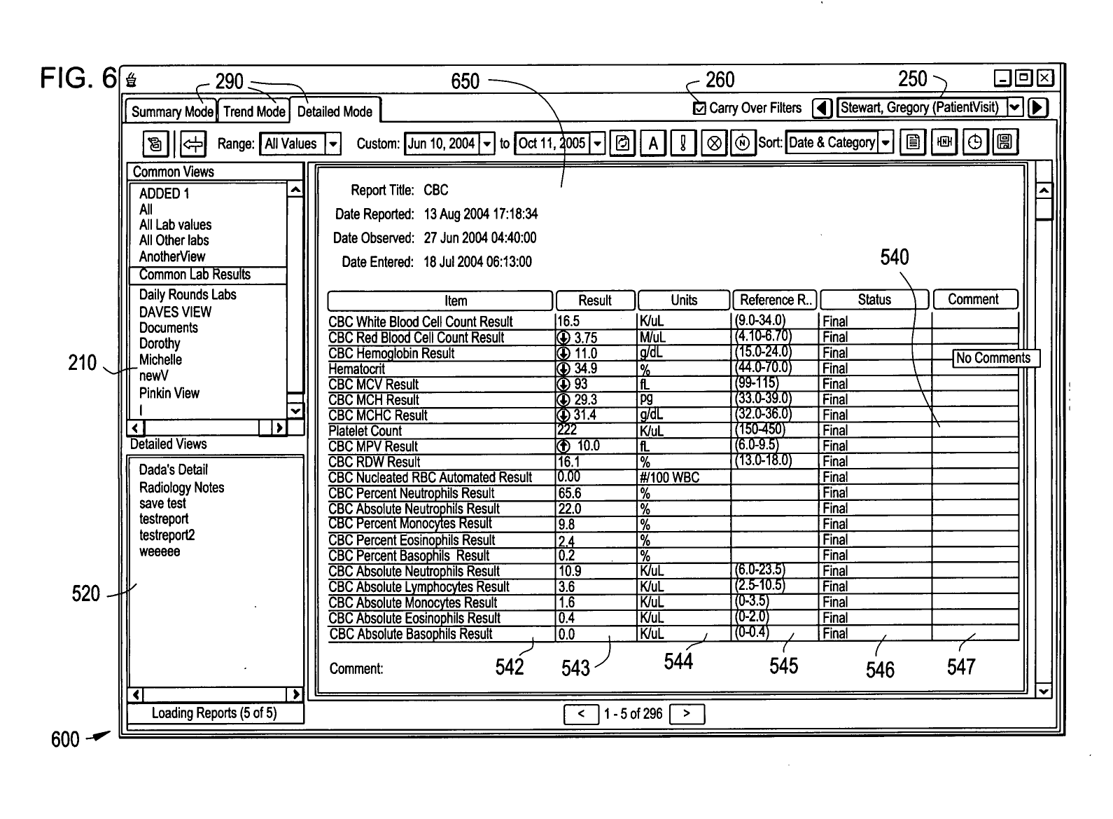

FIG. 6 illustrates a report form screenshot 600 in accordance with an embodiment of the presently described technology. In an embodiment, modification routine 122 causes a display device connected to computing device 110 to present screenshot 600 to a user. While screenshot 600 is provided as an example, it should not be construed as a limitation of an embodiment of the presently described technology. Screenshot 600 includes common view window 210, detailed view window 520, columns 542 through 547, detailed results window 540, patient identification 250, carry-over filter button 260, mode tabs 290, and report form 650. Common view window 210, detailed view window 520, columns 542 through 547, detailed results window 540, patient identification 250, carry-over filter button 260 and mode tabs 290 are described above.

Report form 650 includes additional information about a result selected by a user. For example, report form 650 can include a title of the report or laboratory examination resulting in the results presented to the user. Report form 650 can also include the date and/or time the selected result was first reported, first observed, and/or entered into a database of results. Report form 650 can also include a comment from one or more other users. Report form 650 can also include one or more columns 541 through 547 of information. In an embodiment, one or more columns 541 through 547 of information presented in a report form 650 can be selected by a user to cause the listed results to be sorted according to the respective column.

In an embodiment of the presently described technology, a user can select one or more results presented in a report form 650 to view additional information concerning the laboratory examination or test administered to obtain the result. For example, by employing an input device to select a given result in report form 650, the user's selection is communicated to data collection routine 126, which then accesses a database in computer-readable storage medium 130 to determine if additional information is available. If additional information is available, the additional information is communicated to modification routine 122 which then presents the additional information in a laboratory result form on computing device 110.

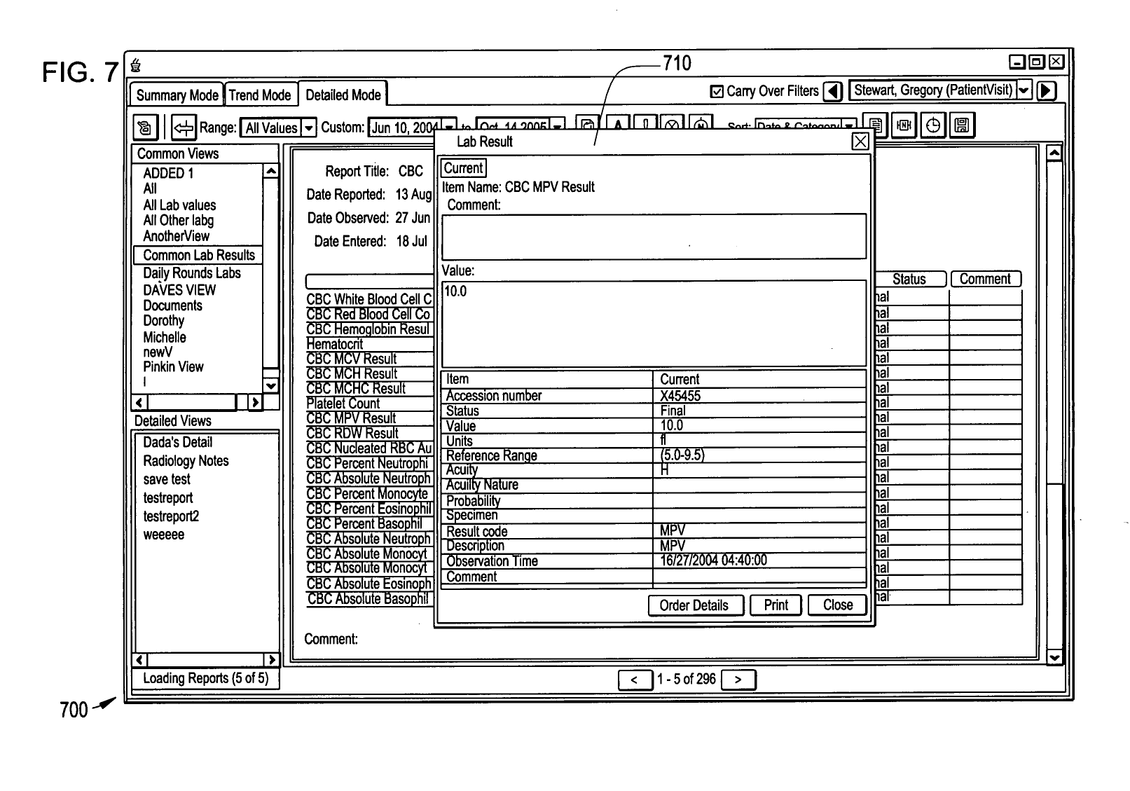

FIG. 7 illustrates a laboratory result form screenshot 700 presenting a laboratory result form 710 in accordance with an embodiment of the presently described technology. In an embodiment, modification routine 122 causes a display device connected to computing device 110 to present screenshot 700 to a user. While screenshot 700 is provided as an example, it should not be construed as a limitation of an embodiment of the presently described technology. Lab result form 710 includes additional information concerning the laboratory test used to obtain a selected result. For example, if a user selects “CBC MTV Result” in detailed results window 540 of screenshot 600, the user's selection is communicated to data collection routine 126 which accesses a database in computer-readable storage medium 130 to determine if additional information is available concerning the lab test used to obtain the CBC MPV Result. If additional information is available, the additional information is communicated to modification routine 122 which then presents this additional information in result form 710. The additional information can include, for example, comments from one or more users, a measured value of the result, an accession number, a status, a unit of measurement, a reference, or normal or expected, range and/or a time and/or date the laboratory test was administered, for example.

As described above, in accordance with an embodiment of the presently described technology, each of the modes available to a user enables the user to select one more views of medical results. That is, for each mode, one or more views of results are available. In an embodiment, one or more views can be customized. That is, a view can be customized to present a particular subset of the universe of medical results.

In an embodiment, a view can be configured by one or more users to automatically present one or more categories of medical results in one or more templates in one or more modes. For example, a view named “Common Lab Results” can be configured to automatically present one or more categories of medical results. A category of medical results can include one or more items or types of medical results, such as “Hematology Results” and “Chemistry Results.” One or more of these can be configured to include subcategories, such as “CBC” and/or “Coag Results,” for example.

A view can be configured to automatically present one or more user-defined categories and/or subcategories of the universe of medical results available to system 100 using a category manager tool and/or a view manager tool. A category manager and view manager tool can be implemented in one or more sets of instructions for a computer, such as in one or more of sets of instructions 120. For example, a category manager tool and/or view manager tool can be implemented as part of modification routine 122.

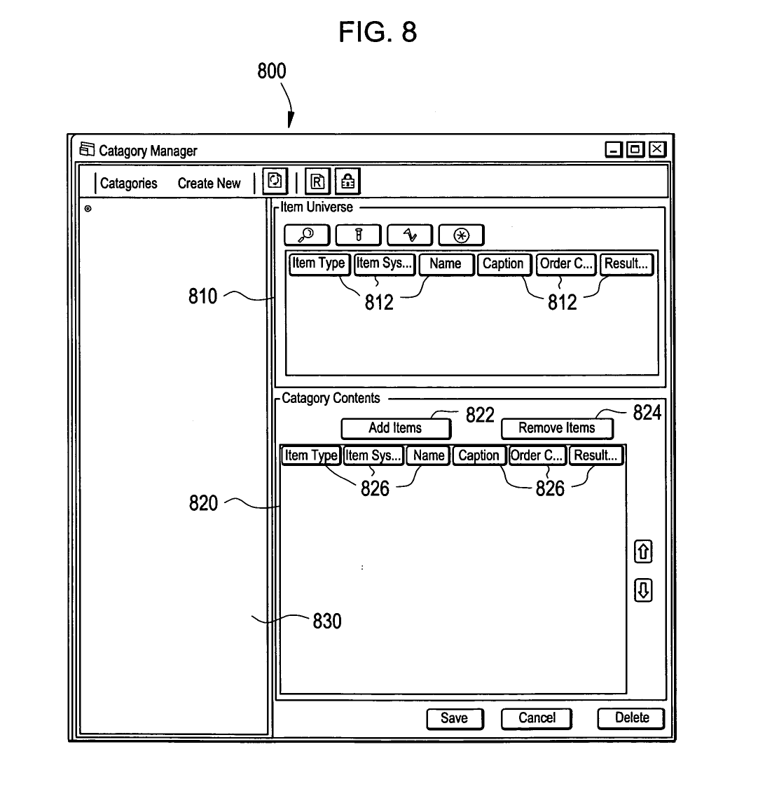

FIG. 8 illustrates a screenshot 800 of a category manager tool in accordance with an embodiment of the presently described technology. In an embodiment, modification routine 122 causes a display device connected to computing device 110 to present screenshot 800 to a user. While screenshot 800 is provided as an example, it should not be construed as a limitation of an embodiment of the presently described technology. Screenshot 800 includes an item search window 810, a category contents window 820, and an available categories window 830. Item search window 810 includes a plurality of item search buttons 812. Category contents window 820 includes a plurality of buttons, including an add items button 822, a remove items button 824, and a plurality of category items buttons 826.

Category manager tool can be employed by a user to select one or more search criteria used to define one or more subsets of medical results included in a category. For example, a user can define search criteria for a given category so that the category includes all results related to laboratory blood tests.

A user can select one or more search criteria by choosing one or more of item search buttons 812. An item search button 812 can represent a search criterion. For example, one or more item search buttons 812 can represent an item type, an item system marker, a name, a caption, an order caption, and/or a particular result.

An item system marker can be any marker or indicator stored with or associated with a medical result that is used to distinguish the medical result from at least one other medical result. For example, where two or more similar laboratory test results exist for a patient, one or more of the results may be stored with or associated with an item system marker to distinguish the result from the other results.

A name can include the name of a user (such as a physician, nurse or administrator) or of a patient.

A caption can include one or more captions or notations added to a result. An order caption can include one or more captions or notations added to an order for a test, examination, or prescription.

By employing an input device, a user can select an item search button 812. The user's selection is communicated to modification routine 122 as user input. Modification routine 122 can then prompt the user for additional information. For example, if a user selected a search button 812 representing an item type, modification routine 122 can prompt the user for additional search criteria, such as one or more text or numerical terms. The additional search criteria are then communicated to data collection routine 126 as user input. Data collection routine 126 then employs the user input to search the universe of medical results for results that include an item type matching (either entirely matching or partially matching) the user's search criteria. For example, if a user inputs “blood” as a search criterion, data collection routine 126 can search the medical results stored at computer readable storage medium 130 to obtain all results with an item type that includes the term “blood.”

In an embodiment, data collection routine 126 can search the medical results stored at computer readable storage medium 130 to obtain all results with an item type that partially matches the term “blood.” For example, results including an item type of “bld” can be considered to partially match the term “blood” and obtained by data collection routine 126.

In another example, if a user selected a search button 812 representing an item system marker, modification routine 122 can prompt the user for additional search criteria, such as one or more text or numerical terms. The additional search criteria are then communicated to data collection routine 126 as user input. Data collection routine 126 then employs the user input to search the universe of medical results for results that include an item system marker matching (either entirely matching or partially matching) the user's search criteria.

In another example, if a user selected a search button 812 representing a name, modification routine 122 can prompt the user for additional search criteria, such as one or more text or numerical terms. The additional search criteria are then communicated to data collection routine 126 as user input. Data collection routine 126 then employs the user input to search the universe of medical results for results that include a name matching (either entirely matching or partially matching) the user's search criteria.

In another example, if a user selected a search button 812 representing a caption or order caption, modification routine 122 can prompt the user for additional search criteria, such as one or more text or numerical terms. The additional search criteria are then communicated to data collection routine 126 as user input. Data collection routine 126 then employs the user input to search the universe of medical results for results that include a caption or order caption matching (either entirely matching or partially matching) the user's search criteria.

In another example, if a user selected a search button 812 representing a result, modification routine 122 can prompt the user for additional search criteria. The additional search criteria can include a number (such as an exact result measurement) and/or a range (such as a range of result measurements). The additional search criteria are then communicated to data collection routine 126 as user input. If the user entered an exact result measurement, data collection routine 126 then employs the user input to search the universe of medical results for results that match the result measurement entered by the user. If the user entered a range of result measurements, data collection routine 126 then employs the user input to search the universe of medical results for results that fall within the range of results entered by the user.

In an embodiment, one or more results of the searches performed by data collection routine 126 can be presented by modification routine 122 to the user on computing device 110 in item universe window 810. The user can then select one or more of the search results to be added to category contents window 820. Once a user has selected a search result (for example by using an input device to highlight a search result), the user can select the add items button 822. The user's selection is communicated to modification routine 122 as user input. The user can continue to select additional search criteria, perform additional searches, and/or select additional results of searches in item universe window 810 for inclusion in category contents window 820. As search results are added to category contents window 820, a customized category is built.

Category window 820 can present all search criteria to be included in a given category. The user can remove search criteria previously added to a category using the remove items button 824. Once a user is finished customizing a category, the user can save the category for later recall. A saved category can be displayed in available categories window 830. Once a category is saved, modification routine 122 stores the search criteria used to create the category at a computer-readable storage medium, such as medium 130.

In an embodiment, category contents window 820 can sort the various search criteria included in a category. For example, a user can select one or more of buttons 826 to sort the various search criteria included in a given category according to the selected button 826.

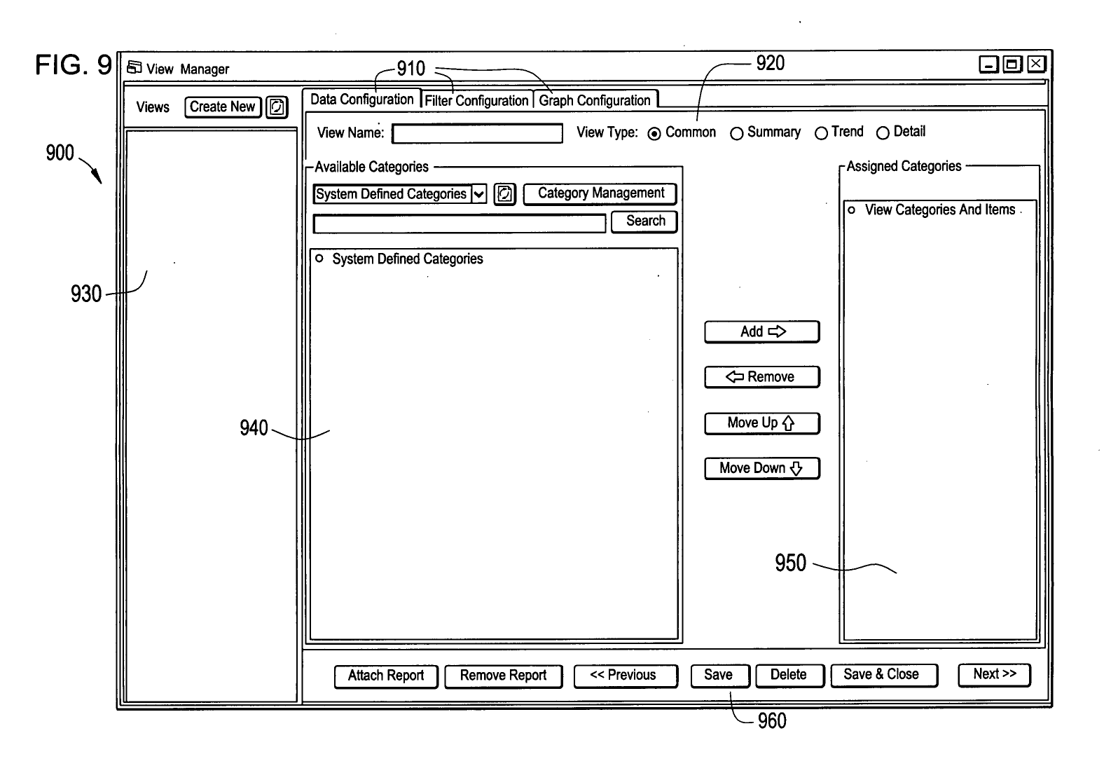

FIG. 9 illustrates a screenshot 900 of a view manager tool in accordance with an embodiment of the presently described technology. In an embodiment, modification routine 122 causes a display device connected to computing device 110 to present screenshot 900 to a user. While screenshot 900 is provided as an example, it should not be construed as a limitation of an embodiment of the presently described technology. Screenshot 900 includes one or more configuration tabs 910, a view configuration window 920, an available views window 930, an available categories window 940, an assigned categories window 950, and a view report window 960.

View manager tool can be employed by a user to customize the results included in a view, the type of view, the name of the view, and/or the visual presentation of the view. For example, a user can select one or more categories of results defined by a category manager tool to be included in a customized view. In another example, a user can determine whether the view is a common view, a summary view, a trend view or a detailed view.

A user can customize the results to be included in a view by using an input device to select the data configuration tab 910. A user can select a category by searching for the category and/or creating a category to be included in a view. For example, a user can search for a category by inputting one or more search terms in a search box in available categories window 940. This input is communicated to modification routine 122, which then searches available categories stored at a computer readable storage medium, such as medium 130. Modification routine 122 can then present the categories that match the user's search in available categories window 940.

The user can then select one or more of the categories presented in available categories window 940 using an input device. Upon selecting one or more categories to be added to a view (for example, by selecting the “Add” button in screenshot 900), the categories are displayed in assigned categories window 950.

A user can also create a category to be included in a view using a category manager tool, as described above. Once the user has created a category, the category can be added to the assigned categories window 950.

A user can customize the filter(s) to be applied in a view by using an input device to select the data configuration tab 910. The user can then select one or more filters to be applied to a view each time the view is selected or accessed. The user's selection of one or more filters can be communicated to modification routine 122. Modification routine 122 can then associate the selected filters with the selected view. For example, modification routine 122 can save the selected filters or links to the filters in a database that relates the filters to one or more views.

A user can customize the appearance of a graph or plot (such as plot 440) to be shown in a view by using an input device to select the graph configuration tab 910. The user can then customize the appearance of a graph, the scale of one or more axes, the legend, and/or the symbols used to represent data in the graph, for example. The user's graph customization can be communicated to modification routine 122. Modification routine 122 can then associate the customization selections with the selected view. For example, modification routine 122 can save the customization selections in a database that relates the selections to one or more graphs in a view.

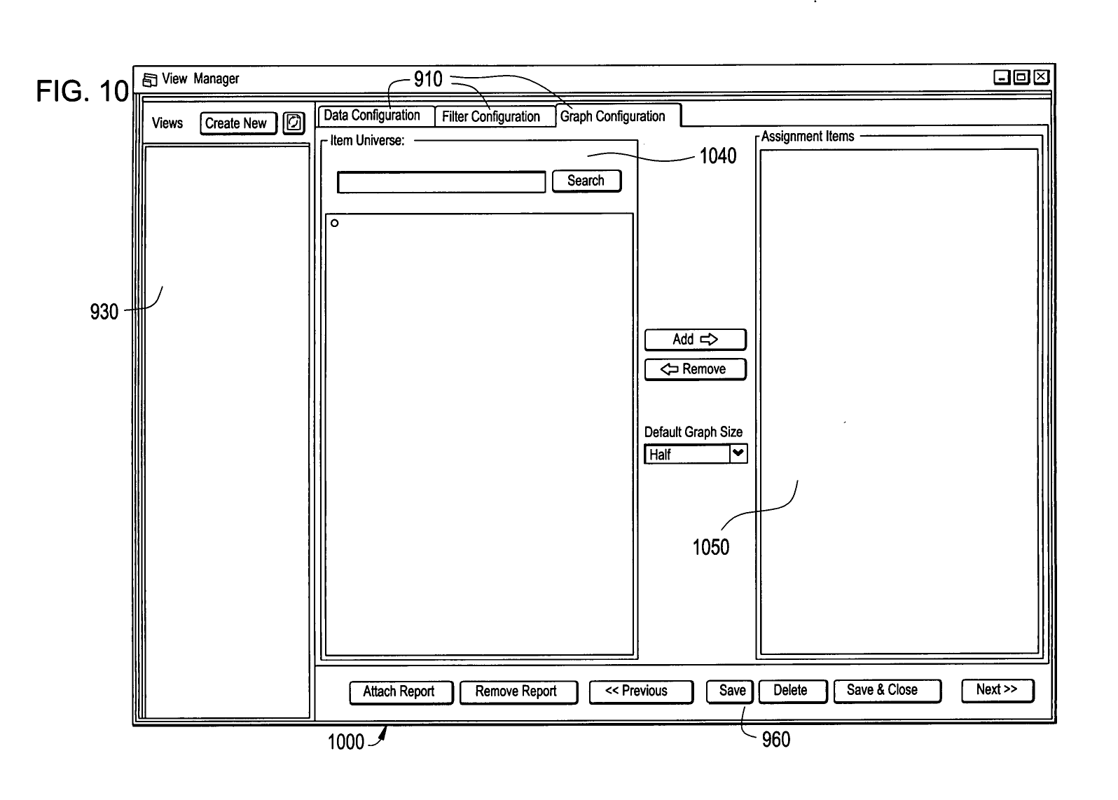

In an embodiment, a user can also customize a graph or plot to be automatically plot or graph one or more results. For example, when a user selects the graph configuration tab 910, the user is presented with a screenshot similar to graph configuration screenshot 1000 of FIG. 10. FIG. 10 illustrates a graph configuration screenshot 1000 in accordance with an embodiment of the presently described technology. In an embodiment, modification routine 122 causes a display device connected to computing device 10 to present screenshot 1000 to a user. While screenshot 1000 is provided as an example, it should not be construed as a limitation of an embodiment of the presently described technology. Screenshot includes configuration tabs 910, available views window 930, view report window 960, an item universe window 1040, and an assigned items window 1050. Configuration tabs 910, available views window 930, and view report window 960 are described herein.

Item universe window 1040 presents a user with the ability to search for one or more items to be included in a graph or plot. For example, a user can search for all items including one or more text or numeric terms, similar to that described above for a user's customization of a category. One or more items are then listed according to the user's search in window 1040.

The user can then select one or more of the items to be included in the graph or plot. Using an input device, the user can highlight one or more items in window 1040 and select the “Add” button in screenshot 1000. The highlighted items are then listed in window 1050. Once a user has selected all the items that he or she wishes to be displayed in a graph or plot for the customized view, the user can save the customization options for the graph.

A user can also customize the name and/or type of a view using view configuration window 920. For example, by inputting a name and/or selecting one of the buttons in window 920 of screenshot 900, a user can create a name that the view is stored under and/or determine what type of view the view is. As described above, certain types of views can be accessible using only certain modes. By determining what type of view a particular view is, a user can control which modes the view can be presented in.

A user can also attach a report to a view and/or a graph or plot. For example, using view report window 960 in screenshots 900 or 1000, a user can select the “Attach Report” button to select a report from a list of reports presented to the user by modification routine 122. The list of reports can be stored at computer readable storage medium 130 and accessed by data collection routine 126. The user can then select one or more reports to be included in and accessible from the view being customized by the user.

In an embodiment, a user can customize the display of a view using a view manager tool. A view manager tool can be implemented in one or more sets of instructions for a computer, such as in one or more of sets of instructions 120. For example, a view manager tool can be implemented as part of modification routine 122.

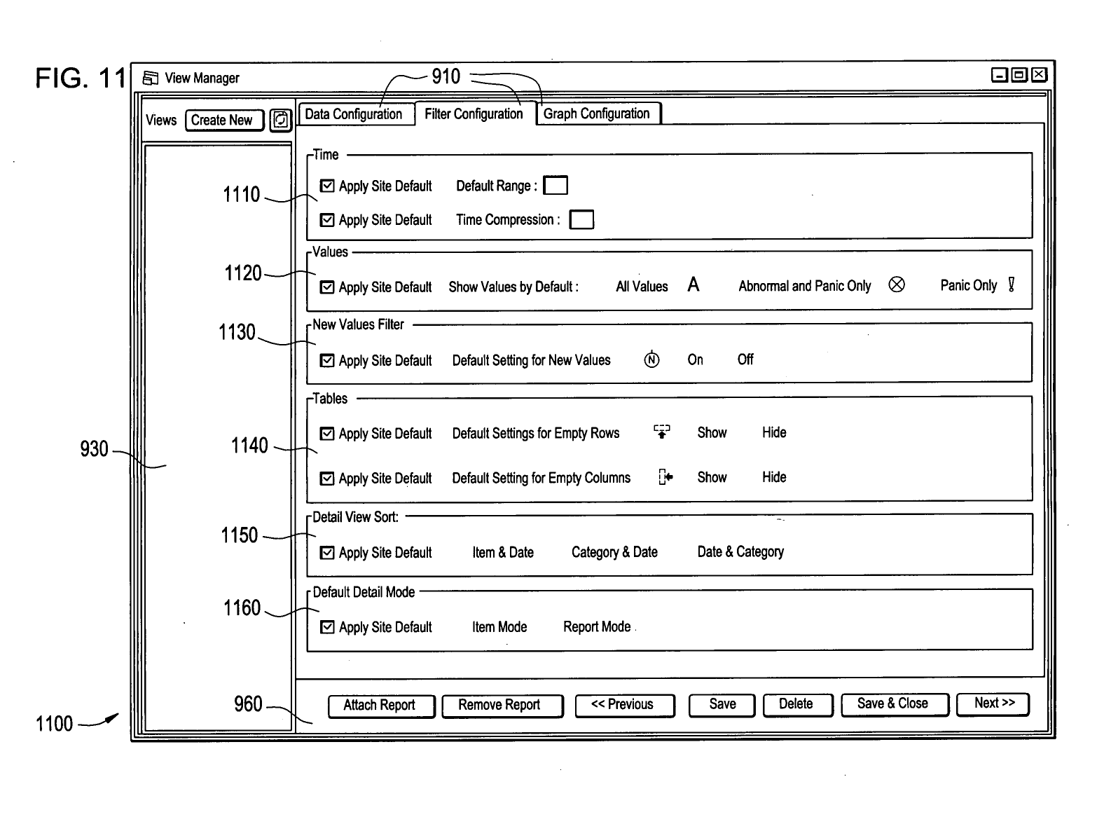

FIG. 11 illustrates a screenshot 1100 of a view manager tool in accordance with an embodiment of the presently described technology. In an embodiment, modification routine 122 causes a display device connected to computing device 110 to present screenshot 1100 to a user. While screenshot 1100 is provided as an example, it should not be construed as a limitation of an embodiment of the presently described technology. Screenshot 1100 includes configuration tabs 910, available views window 930, view report window 960, a time settings window 1110, a values setting window 1120, a new values filter window 1130, a tables settings window 1140, a detail view sort window 1150, and a default detail mode window 1160. Configuration tabs 910, available views window 930, and view report window 960 are described above.

Using an input device, a user first selects which view he or she wishes to configure. For example, a list of available views can be listed in available views window 930. A user can then select a view to be configured.

Once a user has selected a view, the time range and/or time compression for results presented in the view can be customized in time settings window 1110. The time range for a given view is a range of dates and/or times that one or more results presented in the view were obtained. In other words, by establishing a time range for a view, only results that were obtained during that time range are displayed in that view. Using an input device, a user can either select the default time range for the selected view or choose to enter a customized time range.

A user can select the “Time compression” box in window 1110 to turn time compression of results in summary mode on or off. As described above, in summary mode a plurality of results can be time compressed and represented by an icon. By turning time compression on in window 1110, the results in summary mode will be time compressed.

The values setting window 1120 can be used to customize which results are displayed in the selected view. For example, a user can customize a view so that all results included in the view are presented to a user, only those results that are abnormal or critical are displayed to a user, or only those results that are critical are displayed to a user.

The new values filter window 1130 can be used to customize whether a graphical icon is presented next to results in the selected view. The graphical icon can be presented next to results that have been added to the database of medical results stored at computer readable storage medium 130 since the last time a given user accessed the selected view.

The tables settings filter window 1140 can be used to customize the presentation of one or more tables in the selected view. For example, a user can choose whether a table in the selected view displays empty columns and/or rows (that is, columns and/or rows with no medical results listed) or whether such columns and/or rows are not displayed at all.

The detail view sort window 1150 can be used to customize how results are initially sorted in the selected view. For example and as described above, results can be sorted in detailed results window 540. The initial sorting of results can be set by a user through detail view sort window 1150. For example, the user can set the initial sorting of results to be according to item and date, category and date (as described above), or date and category (as described above).

The default detail mode window 1160 can be used to customize which view is presented to a user when a user selects a result. As described above, by selecting a result or group of results in time compression, a user can “drill down” to continue to see additional details concerning the result. The user can also go into a “report mode” where the laboratory report corresponding to the result is presented to the user when the user selects the result. Alternatively, the user can go into an “item” or “detailed mode”, as described above, which displays additional information about a result when that result is selected. By selecting either “Item mode” or “Report mode” in window 1160, the user can customize which mode occurs when a result is selected in the customized view.

In an embodiment, once a user has customized the contents of a view, the user's selections are communicated to modification routine 122. Modification routine 122 then saves the user's selections at a computer readable storage medium at computing device 110 or at another medium such as medium 130. In an embodiment, the user's customization selections are saved in a database that associates the user's name or identity with the user's customization selections. In another embodiment, the user's customization selections are saved in a database that associates the name of the view with the user's customization selections.

After a user has customized a view, the view can then be later accessed by that user and/or one or more other users. As described above, one or more views can be presented in and selected from one or more of common view window 210, summary view window 220, trend view window 320, and detailed view window 520. A user's customized view can also be displayed in one or more of these windows and selected for display by one or more other users. For example, a user can create a view entitled “Common Lab Results” that includes several categories of medical results, such as “Hematology Results” and “Chemistry Results.” When the “Common Lab Results” view is selected later on, the categories of medical results associated with the view are automatically presented to the user. In this way, a user can create a preferred customized view for a given subset of medical results available for viewing. The user can then access the customized view to automatically present the subset of medical results according to the user's preferences, thereby reducing the amount of time a user must spend re-arranging and accessing medical results into a preferred view.

In an embodiment, a user can customize the default display options of the various modes available for viewing results using a view configurator tool. A view configurator tool can be implemented in one or more sets of instructions for a computer, such as in one or more of sets of instructions 120. For example, a view configurator tool can be implemented as part of modification routine 122.

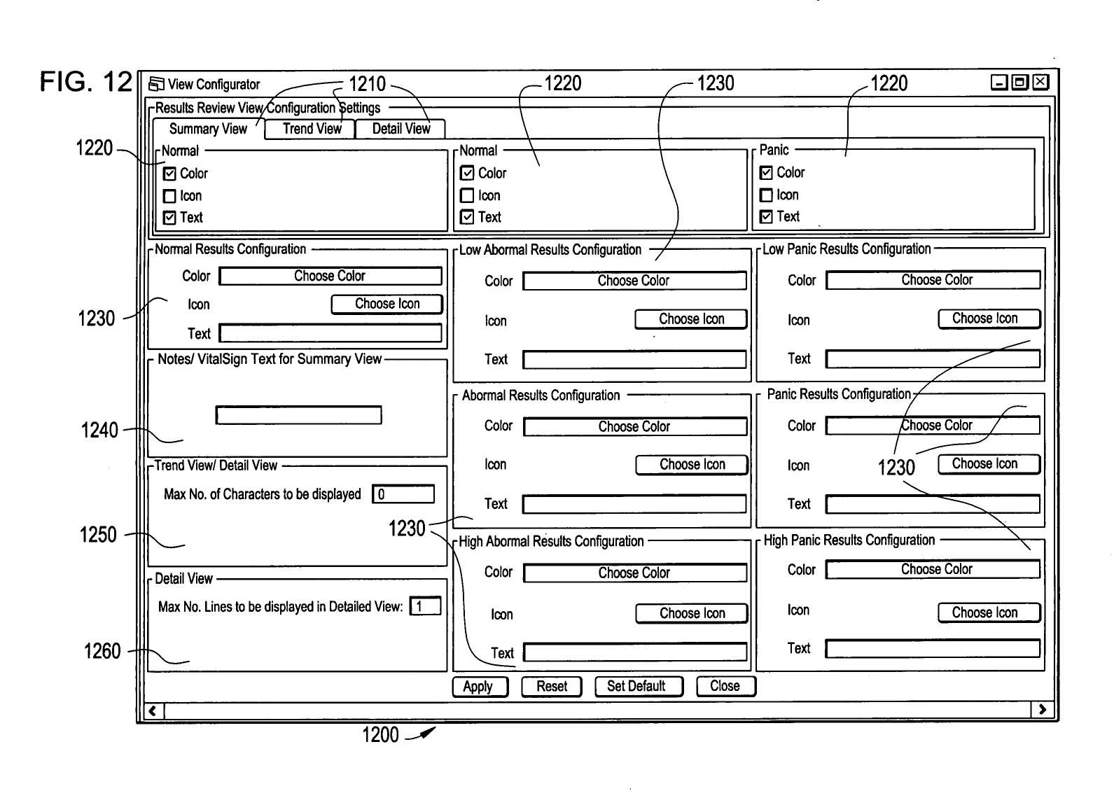

FIG. 12 illustrates a screenshot 1200 of a view configurator tool in accordance with an embodiment of the presently described technology. In an embodiment, modification routine 122 causes a display device connected to computing device 110 to present screenshot 1200 to a user. While screenshot 1200 is provided as an example, it should not be construed as a limitation of an embodiment of the presently described technology. Screenshot 1200 includes a plurality of mode tabs 1210, a plurality of display options windows 1220, a plurality of results configuration windows 1230, a notes window 1240, a trend/detail view character window 1250, and a detail line window 1260.

Using an input device, a user first selects which mode he or she wishes to configure the default settings for. For example, by selecting one of mode tabs 1210, a user can select which mode he or she will customize the default view settings for.

Once a user has selected a mode, a user can select whether results are displayed in the selected mode (1) in colored text (and which color is used), (2) along with a graphical icon (such as 241, 243, 342, 344, for example), and (3) with accompanying text. For example, if a user selects “color” for normal results, each normal result displayed in the selected mode is displayed in a selected color. The user can then select which color is used for the selected result in one or more of the results configuration windows 1230.

In another example, if a user selects “icon” for abnormal results, each abnormal result displayed in the selected mode is displayed along with a graphical icon. In another embodiment, if a user selects “icon” for a type of result, each result of that type displayed in the selected mode is displayed as a graphical icon rather than the actual result. For example, one or more of icons 241, 243 can be displayed in place of the actual result. The user can then select which icon is used for the selected result in one or more of the results configuration windows 1230.

In another example, if a user selects “text” for panic results, each panic result displayed in the selected mode is displayed along with a text message. The user can then customize the text message that is displayed with the selected result in one or more of the results configuration windows 1230. By allowing users to customize the text displayed with various results, the terminology used in a given healthcare facility can be implemented in system 100.

A user can customize a notes text for summary view in window 1240. The notes text is the text message that is displayed in summary mode to represent a user's note displayed in summary mode. In other words, as described above, one or more notes from a doctor or nurse can be displayed in summary mode. These notes can be represented by, for example, the text message that is selected by a user in window 1240. For example, the text message can be a hyperlink that states “Click here for more information.” Upon clicking on the text message, the user is presented with the note that is represented by the text message.

A user can customize the maximum number of characters to be displayed in trend mode or in detail mode in window 1250. For example, given a certain screen resolution or size, a user may desire to limit the number of characters used to describe a result or a category of results in trend mode views and/or detailed mode views. Using window 1250, the user can adjust this maximum character size.

A user can customize the maximum number of lines to be displayed in detailed mode in window 1260. For example, given a certain screen resolution or size, a user may desire to limit the number of lines displayed in detailed mode views. Using window 1260, the user can adjust this maximum lines number.

In an embodiment, once a user has customized the default settings for a mode, the user's selections are communicated to modification routine 122. Modification routine 122 then saves the user's selections at a computer readable storage medium at computing device 110 or at another medium such as medium 130. In an embodiment, the user's customization selections are saved in a database that associates the user's name or identity with the user's customization selections. In another embodiment, the user's customization selections are saved in a database that associates the type of mode with the user's customization selections.

After a user has customized a mode, views within that mode can be accessed by that user and/or one or more other users and presented with results in views according to the user's customization of the mode. A user can therefore create a preferred default style for all views in a given mode.

In an embodiment of the presently described technology, any one or more of the customization options described herein can be defined for a given user or group of users, a type of user, a role, a system, a patient or group of patients, and/or a type of patient. For example, the customization of a view, category, and/or mode can be associated with a given user. When that user later accesses a customized view, category, and/or mode, one or more of selection routine 124, data collection routine 126, and modification routine 122 accesses the relevant results (that is, the results included in any customized options for a view and/or category) and presents the results according to the customization options.

In another example, a group of users can be associated with the customization of a view, category, and/or mode. That way, when any member of the group later accesses a customized view, category, and/or mode, one or more of selection routine 124, data collection routine 126, and modification routine 122 accesses the relevant results (that is, the results included in any customized options for a view and/or category) and presents the results according to the customization options for the group.

In another example, a role can be associated with the customization of a view, category, and/or mode. In general, a role is a position in a hospital. For example, a role can be a physician, a nurse, an administrator, a type of physician, a type of nurse, or a patient.

In another example, all users of a particular system 100 can be associated with the customization of a view, category, and/or mode. A single healthcare organization can use multiple systems 100. For example, different departments of a single hospital can have different systems 100. When a user of a particular system accesses a customized view, category, and/or mode, one or more of selection routine 124, data collection routine 126, and modification routine 122 accesses the relevant results (that is, the results included in any customized options for a view and/or category) and presents the results according to the customization options for the particular system 100.

In another example, all results for a patient and/or group of patients can be associated with the customization of a view, category, and/or mode. When a user accesses results for the patient and/or group of patients using a customized view, category, and/or mode, one or more of selection routine 124, data collection routine 126, and modification routine 122 accesses the relevant results (that is, the results included in any customized options for a view and/or category for the patient and/or group of patients) and presents the results according to the customization options for the particular patient and/or group of patients.

In another example, all results for a type of patient can be associated with the customization of a view, category, and/or mode. A type of patient can be a medical definition of a human undergoing a common examination and/or treatment, or suffering from a common ailment, for example. For example, Type I diabetics can be a type of patient. When a user accesses results for a patient of a given type using a customized view, category, and/or mode, one or more of selection routine 124, data collection routine 126, and modification routine 122 accesses the relevant results (that is, the results included in any customized options for a view and/or category for that type of patient) and presents the results according to the customization options for that particular type of patient.

In an embodiment of the present invention, certain results in the universe of medical results accessible by system 100 can be blocked from viewing by certain users. For example, certain results, such as HIV test results, are highly confidential. In order to ensure that certain results are only accessible by certain users, one or more users can be blocked from accessing certain results using system 100.

The blocking of access to results can be implemented by associating each user with a subset of the universe of results stored at computer readable storage medium 130. Data collection routine 126 can then be prevented from accessing results that a particular user is not associated with.

In another example, one or more categories of medical results can be blocked from viewing by certain users. The blocking of access to categories of results can be implemented by associating each user with a subset of the universe of categories of results stored at computer readable storage medium 130. Data collection routine 126 can then be prevented from accessing categories of results that a particular user is not associated with.

In an embodiment of the presently described technology, system 100 can be used to generate a printed report of medical results. For example, in one or more of summary, detailed and trend mode, a user can select one or more medical results and/or one or more categories of medical results. The selected results are then communicated to an output device, such as a printer connected to computing device 110. The selected results are then printed in hard copy format for a user.

In an embodiment, while in any one or more of summary, trend and detailed modes, a user can select one or more results displayed on computing device 110 to see an electronic copy of a report filed by the physician, nurse, radiologist, or administrator containing the selected results. Upon receiving the user input from computing device 110, data collection routine 126 obtains the electronic copy of the report from memory 130. The report is then presented to the user by modification routine 122.

In an embodiment, a user can view one or more results that were obtained at the same time a selected result was obtained. For example, when a user selects a result on computing device 110, data collection routine 126 can obtain all other results that were obtained on the same date as the selected results or at the same time as the selected result. The other results can then be presented to the user by modification routine 122.

In an embodiment, the results presented according to a particular view can be automatically updated. One or more sets of instructions for a computer (such as an update routine, for example) stored on a computer readable storage medium (such as a memory on computing device 110, medium 130, or some other computer readable storage medium) can automatically update the subset of results presented in a particular view when additional information or results become available. For example, if a given view presents all laboratory test results for a patient's cholesterol test, then the cholesterol test results can be updated by an update routine as soon as the additional results become available. The updating can occur transparently to the user. In this way, a user accessing results for one or more patients can have the most up to date test results presented to him or her.

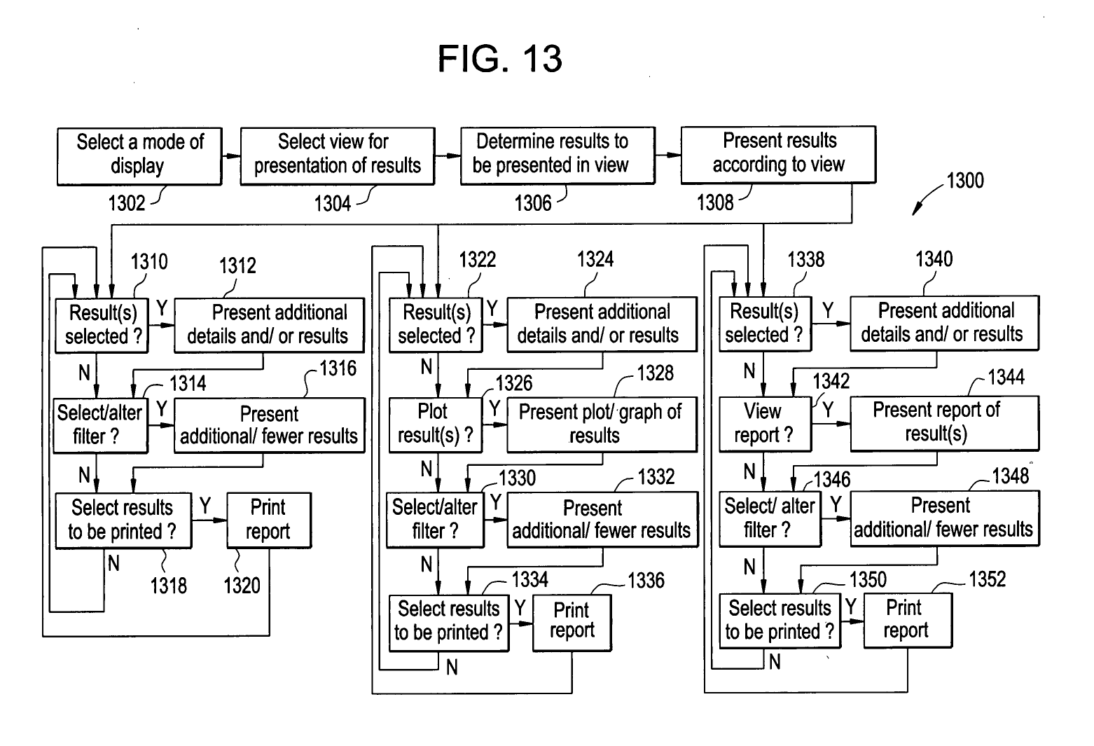

FIG. 13 illustrates a flowchart for a method 1300 of results reviewing in accordance with an embodiment of the presently described technology. First, at step 1302, a mode of display is selected. As described above, a user can select a summary mode, trend mode, or display mode in accordance with an embodiment of the presently described technology.

Next, at step 1304, a view is selected for the presentation of a subset of the universe of medical results. As described above, for a given mode, one or more views can be selected for the presentation of a subset of results. For example, a common view can be presented in any of summary, detailed and trend modes, a detailed view can be presented in detailed mode, a summary view can be presented in summary mode, and a trend view can be presented in trend mode.

Next, at step 1306, a determination is made as to what subset of results from the universe of medical results is to be presented according to the settings of the view selected at step 1304. As described above, a view can be customized to present one or more categories of results according to one or more filters, for example. Therefore, at step 1306 a determination is made as to what results are to be included and presented in the selected view.

Next at step 1308, the results determined in step 1306 are presented according to the view selected in step 1304, as described above. For example, the results can be presented in a spreadsheet format displaying actual result values and/or graphical icons representing results or trends in results, in a graph or plot of one or more categories or items of results, or in a detailed listing format, as described above. Next, depending on which mode was selected at step 1302, method 1300 can proceed to either step 1310, 1322 or 1338.

If the mode selected at step 1302 is summary mode, method 1300 next proceeds to step 1310. At step 1310, a determination is made as to whether one or more results have been selected by a user in order to obtain additional details about the result(s). If a user has selected one or more results, method 1300 proceeds to step 1312. At step 1312, one or more additional details concerning the result(s) are presented. For example, the date and/or time the result was obtained can be presented, the name of the physician or nurse that administered the test or examination resulting in the result can be presented, or additional results obtained at the same time the selected result was obtained can be presented. After step 1312, method 1300 proceeds to step 1314.

If a user did not select one or more results at step 1310, method 1300 proceeds to step 1314. At step 1314, a determination is made as to whether the user has selected and/or altered a filter for the results presented in the view. If the user has selected and/or altered a filter, method 1300 proceeds to step 1316. At step 1316, the filter is applied to the presented results, as described above. Method 1300 then proceeds to step 1318.

If the user has not selected and/or altered a filter, from step 1314 method 1300 proceeds to step 1318. At step 1318, a determination is made as to whether a user has selected one or more results to be included in a printed report. If the user did select one or more results at step 1318, method 1300 proceeds to step 1320. At step 1320, the selected result(s) are printed in a report. In an embodiment, the report can include additional information regarding the selected results, such as the time and/or date the result was obtained and/or additional results obtained at the same time as the selected results, for example. Next, method 1300 proceeds to step 1310.

If the user did not select one or more results at step 1318, method 1300 proceeds to step 1310.

If the mode selected at step 1302 is trend mode, method 1300 proceeds from step 1308 to step 1322. At step 1322, a determination is made as to whether one or more results have been selected by a user in order to obtain additional details about the result(s). If a user has selected one or more results, method 1300 proceeds to step 1324. At step 1324, one or more additional details concerning the result(s) are presented. For example, the date and/or time the result was obtained can be presented, the name of the physician or nurse that administered the test or examination resulting in the result can be presented, or additional results obtained at the same time the selected result was obtained can be presented. After step 1324, method 1300 proceeds to step 1326.

If a user did not select one or more results at step 1322, method 1300 proceeds to step 1326. At step 1326, a determination is made as to whether the user has selected one or more items or types of results and/or categories of results to be plotted in a plot or graph, as described above.

If the user did select one or more items/types of results and/or categories of results at step 1326, method 1300 proceeds to step 1328. At step 1328, the selected items/types/categories of results are plotted on one or more graphs, as described above. After step 1328 or if the user did not select one or more items/types/categories of results at step 1326, method 1300 proceeds to step 1330.

At step 1330, a determination is made as to whether the user has selected and/or altered a filter for the results presented in the view. If the user has selected and/or altered a filter, method 1300 proceeds to step 1332. At step 1332, the filter is applied to the presented results, as described above. Method 1300 then proceeds to step 1334.

If the user has not selected and/or altered a filter, from step 1330 method 1300 proceeds to step 1334. At step 1334, a determination is made as to whether a user has selected one or more results to be included in a printed report. If the user did select one or more results at step 1334, method 1300 proceeds to step 1336. At step 1336, the selected result(s) are printed in a report. In an embodiment, the report can include additional information regarding the selected results, such as the time and/or date the result was obtained and/or additional results obtained at the same time as the selected results, for example. Next, method 1300 proceeds to step 1322.

If the user did not select one or more results at step 1334, method 1300 proceeds to step 1322.

If the mode selected at step 1302 is detailed mode, method 1300 proceeds from step 1308 to step 1338. At step 1338, a determination is made as to whether one or more results have been selected by a user in order to obtain additional details about the result(s). If a user has selected one or more results, method 1300 proceeds to step 1340. At step 1340, one or more additional details concerning the result(s) are presented. For example, the date and/or time the result was obtained can be presented, the name of the physician or nurse that administered the test or examination resulting in the result can be presented, or additional results obtained at the same time the selected result was obtained can be presented. After step 1340, method 1300 proceeds to step 1342.

If a user did not select one or more results at step 1338, method 1300 proceeds to step 1342. At step 1342, a determination is made as to whether the user has selected one or more items or types of results and/or categories of results to be viewed in a report, as described above. The report can include additional information concerning the selected result(s), for example.

If the user did select one or more items/types of results and/or categories of results at step 1342, method 1300 proceeds to step 1344. At step 1344, one or more reports associated with the selected result(s) is presented to the user, as described above. After step 1344 or if the user did not select one or more items/types/categories of results at step 1342, method 1300 proceeds to step 1346.

At step 1346, a determination is made as to whether the user has selected and/or altered a filter for the results presented in the view. If the user has selected and/or altered a filter, method 1300 proceeds to step 1348. At step 1348, the filter is applied to the presented results, as described above. Method 1300 then proceeds to step 1350.

If the user has not selected and/or altered a filter, from step 1346 method 1300 proceeds to step 1350. At step 1350, a determination is made as to whether a user has selected one or more results to be included in a printed report. If the user did select one or more results at step 1350, method 1300 proceeds to step 1352. At step 1352, the selected result(s) are printed in a report. In an embodiment, the report can include additional information regarding the selected results, such as the time and/or date the result was obtained and/or additional results obtained at the same time as the selected results, for example. Next, method 1300 proceeds to step 1354.

If the user did not select one or more results at step 1350, method 1300 proceeds to step 1338.

While particular elements, embodiments and applications of the presently described technology have been shown and described, it is understood that the presently described technology is not limited thereto since modifications may be made by those skilled in the technology, particularly in light of the foregoing teaching. It is therefore contemplated by the appended claims to cover such modifications and incorporate those features that come within the spirit and scope of the presently described technology.

What is claimed is:

1. A method for customizing the presentation of results from medical examinations, said method including:
selecting at least one of a plurality of views, each of said plurality of views configured to present medical results to a user;
presenting said medical results according to said selected view; and
dynamically modifying said selected view of said medical results based on input from said user.

2. The method of claim 1, wherein said plurality of views includes:
a summary view configured to display said medical results, a time and/or date at which each of said medical results was obtained, and a description of each type of said medical results;
a trend view configured to display, for one or more of said medical results, a change in one or more of said medical results with respect to a previous medical result and/or a graph of one or more of said medical results; and
a detailed view configured to display, for one or more of said medical results, (1) a time and/or date at which said medical result was obtained, (2) said medical result, (3) said description of said type of said medical result, (4) said change in said medical result, (5) a unit of measurement for said medical result, and (6) a comment from a medical practitioner.

3. The method of claim 1, further including automatically updating one or more of said medical resultsmedical result.

4. The method of claim 1, further including selecting said medical results medical resultbased on one or more categories determined by said user, said categories each including a search criteria used to select a subset of said medical resultsmedical resultmedical result.

5. The method of claim 4, further including dynamically modifying said search criteria based on input from said user.

6. The method of claim 1, wherein said dynamically modifying step includes dynamically modifying said medical results based on input from said user, said input including one or more of a selection of one or more of said medical results, a selection of a range of times and/or dates during which one or more of said medical results were obtained, a patient name associated with one or more of said medical results, and a filter of said medical results.

7. The method of claim 6, further including presenting additional details of said medical results in said selection, said additional details including one or more of (1) a time and/or date at which said medical result was obtained, (2) said medical result, (3) said description of said type of said medical result, (4) said change in said medical result, (5) a unit of measurement for said medical result, and (6) a comment from a medical practitioner.

8. The method of claim 1, wherein each of said medical results includes one or more of a result from a laboratory test, a comment from a medical practitioner, one or more measured vital signs of a patient, an image of an anatomy of said patient, a comparison study of said patient, one or more fluids administered to said patient, and one or more fluids discharged by said patient.

9. A computer-readable storage medium including a set of instructions for a computer, said instructions including:
a selection routine configured to select at least one of a plurality of views based on input from a user, each of said plurality of views including a template for presentation of one or more medical results to said user; and
a modification routine configured to dynamically modify said template of one or more of said views based on input from said user.

10. The set of instructions of claim 9, wherein said plurality of views includes:
a summary view configured to display said subset of medical results, a time and/or date at which each of said medical results in said subset was obtained, and a description of each type of said medical results in said subset;
a trend view configured to display, for one or more of said medical results in said subset, a change in one or more of said medical results with respect to a previous medical result and/or a graph of one or more of said medical results in said subset with respect to time; and
a detailed view configured to display, for one or more of said medical results in said subset, (1) a time and/or date at which said medical result was obtained, (2) said medical result, (3) said description of said type of said medical result, (4) said change in said medical result, (5) a unit of measurement for said medical result, and (6) a comment from a medical practitioner.

11. The set of instructions of claim 9, further including an update routine configured to automatically update one or more of said medical results in said plurality of medical results.

12. The set of instructions of claim 9, wherein said template of each of said plurality of views includes one or more categories of medical results to be displayed in said view, said categories each including a search criteria used to select said subset of medical results from said plurality of medical results.

13. The set of instructions of claim 12, wherein said modification routine is configured to dynamically modify said search criteria based on input from said user.

14. The set of instructions of claim 9, wherein said modification routine is configured to dynamically modify said medical results included in said subset and displayed to said user based on input from said user, said input including one or more of a selection of one or more of said medical results, a selection of a range of times and/or dates during which one or more of said medical results were obtained, a patient name associated with one or more of said medical results, and a predefined filter of said medical results.

15. The set of instructions of claim 14, wherein said modification routine is configured to present additional details of said medical results in said selection, said additional details including one or more of (1) a time and/or date at which said medical result was obtained, (2) said medical result, (3) said description of said type of said medical result, (4) said change in said medical result, (5) a unit of measurement for said medical result, and (6) a comment from a medical practitioner.

16. The set of instructions of claim 9, wherein each of said medical results includes one or more of a result from a laboratory test, a comment from a medical practitioner, one or more measured vital signs of a patient, an image of an anatomy of said patient, a comparison study of said patient, one or more fluids administered to said patient, and one or more fluids discharged by said patient.

17. A system for reviewing results from one or more medical examinations, said system including:
a remote computer-readable storage medium including a set of medical results for a plurality of patients; and
a computing device including a computer-readable storage medium, said computer-readable storage medium including a set of instructions for said computing device, said set of instructions including:
a selection routine configured to select at least one of a plurality of views based on input from a user, each of said plurality of views including a template for presentation of a subset of said set of medical results to said user; and
a modification routine configured to dynamically modify said template of one or more of said views based on input from said user.

18. The system of claim 17, wherein said plurality of views includes:
a summary view configured to display said subset of medical results, a time and/or date at which each of said medical results in said subset was obtained, and a description of each type of said medical results in said subset;
a trend view configured to display, for one or more of said medical results in said subset, a change in one or more of said medical results with respect to a previous medical results and/or a graph of one or more of said medical results in said subset with respect to time; and
a detailed view configured to display, for one or more of said medical results in said subset, (1) a time and/or date at which said medical result was obtained, (2) said medical result, (3) said description of said type of said medical result, (4) said change in said medical result, (5) a unit of measurement for said medical result, and (6) a comment from a medical practitioner.

19. The system of claim 17, wherein one or more of said medical results in said set of medical results is updated automatically.

20. The system of claim 17, wherein said template of each of said plurality of views includes one or more categories of medical results to be displayed in said view, said categories each including a search criteria used to select said subset of medical results from said set of medical results.

21. The system of claim 20, wherein said modification routine is configured to dynamically modify said search criteria based on input from said user.

22. The system of claim 17, wherein said computing device includes a display device configured to to present said subset of medical results according a view selected by said user.

23. The system of claim 22, wherein said modification routine is configured to dynamically modify said medical results included in said subset and displayed to said user based on input from said user, said input including one or more of a selection of one or more of said medical results, a selection of a range of times and/or dates during which one or more of said medical results were obtained, a patient name associated with one or more of said medical results, and a predefined filter of said medical results.

24. The system of claim 23, wherein said modification routine is configured to present additional details of said medical results in said selection, said additional details including one or more of (1) a time and/or date at which said medical result was obtained, (2) said medical result, (3) said description of said type of said medical result, (4) said change in said medical result, (5) a unit of measurement for said medical result, and (6) a comment from a medical practitioner.

25. The system of claim 17, wherein each of said medical results includes one or more of a result from a laboratory test, a comment from a medical practitioner, one or more measured vital signs of a patient, an image of an anatomy of said patient, a comparison study of said patient, one or more fluids administered to said patient, and one or more fluids discharged by said patient.
